(19) United States
(12) Patent Application Publication
(10) Pub. No.: US 2019/0208211 A1
(43) Pub. Date: Jul. 4, 2019

(54) GENERATED AFFINE MOTION VECTORS

(71) Applicant: QUALCOMM Incorporated, San Diego, CA (US)

(72) Inventors: Kai Zhang, San Diego, CA (US); Wei-Jung Chien, San Diego, CA (US); Li Zhang, San Diego, CA (US); Marta Karczewicz, San Diego, CA (US)

(21) Appl. No.: 16/238,405

(22) Filed: Jan. 2, 2019

Related U.S. Application Data
(60) Provisional application No. 62/613,581, filed on Jan. 4, 2018.

(51) Int. Cl. H04N 19/139; H04N 19/517; H04N 19/159; H04N 19/70; H04N 19/176

(52) U.S. Cl. CPC H04N 19/139; H04N 19/517; H04N 19/176; H04N 19/70; H04N 19/159

(57) ABSTRACT

Techniques are described for determining control point motion vectors for affine motion prediction based on motion vectors of previously coded blocks. A video coder determines sets of motion vectors and determines motion vectors from each set that point to the same reference picture. The video coder determines control point motion vectors based on the determine motion vectors from each set that point to the same reference picture.

This application claims the benefit of U.S. Provisional Application No. 62/613,581, filed Jan. 4, 2018, the entire content of which incorporated by reference herein.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the ITU-T H.265, High Efficiency Video Coding (HEVC), standard, other standards, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Spatial or temporal prediction results in a predictive block for a block to be coded.

Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized.

### SUMMARY

In general, this disclosure describes examples of techniques related to inter-picture prediction, such as techniques for generating control point motion vectors (also called affine motion vectors) from normal motion vectors. Such techniques may be applied to existing video coding standards such as the H.265, High Efficiency Video Coding (HEVC), video coding standard, or future video coding standards such as the upcoming H.266 standard.

Affine motion prediction is an example type of motion prediction where a video encoder and/or video decoder (e.g., commonly referred to as a video coder) determines control point motion vectors for one or more control points, which are generally corner points on a block. Control point motion vectors may also be referred to as affine motion vectors. Based on the control point motion vectors for the one or more control points, the video coder determines motion vectors for sub-blocks inside the block.

This disclosure describes example techniques to determine the control motion vectors based on motion vectors of other previously coded blocks (e.g., neighboring blocks or collocated blocks). For the control points, the video coder may evaluate respective sets of motion vectors of other blocks. In some examples, the video coder may select respective motion vectors from each set of motion vectors that point to the same reference picture. The video coder may then set the affine motion vectors for the control points based on the selected respective motion vectors.

In this way, the video coder may select control point motion vectors for control points from other previously coded blocks, which reduces the amount of information that needs to be signaled, thereby promoting signaling bandwidth. Moreover, by ensuring that the selected motion vectors point to the same reference picture, motion vector scaling may not be needed, which may reduce the number of computations that need to be performed.

In one example, the disclosure describes a method of decoding video data, the method comprising determining that a first motion vector in a first set of motion vectors and a second motion vector in a second set of motion vectors point to a same reference picture, determining control point motion vectors for a current block based on the first motion vector and the second motion vector that point to the same reference picture, and decoding the current block based on the determined control point motion vectors.

In one example, the disclosure describes a method of encoding video data, the method comprising determining that a first motion vector in a first set of motion vectors and a second motion vector in a second set of motion vectors point to a same reference picture, determining a first control point motion vector and a second control point motion vector for a current block, wherein the first control point motion vector and the second control point motion vector are one of equal to the first motion vector and the second motion vector, respectively, or equal to the first motion vector plus a first motion vector difference and the second motion vector plus a second motion vector difference, respectively. The method also includes encoding the current block based on the determined first control point motion vector and the second control point motion vector.

In one example, the disclosure describes a device for decoding video data, the device comprising a memory configured to store information indicative of reference pictures to which motion vectors point and a video decoder comprising at least one of fixed-function or programmable circuitry. The video decoder is configured to determine that a first motion vector in a first set of motion vectors and a second motion vector in a second set of motion vectors point to a same reference picture based on the stored information, determine control point motion vectors for a current block based on the first motion vector and the second motion vector that point to the same reference picture, and decode the current block based on the determined control point motion vectors.

In one example, the disclosure describes a computer-readable storage medium storing instructions thereon that when executed cause one or more processors of a device for encoding video data to determine that a first motion vector in a first set of motion vectors and a second motion vector in a second set of motion vectors point to a same reference picture, determine a first control point motion vector and a second control point motion vector for a current block, wherein the first control point motion vector and the second control point motion vector are one of equal to the first motion vector and the second motion vector, respectively or equal to the first motion vector plus a first motion vector difference and the second motion vector plus a second motion vector difference, respectively. The instructions further cause the one or more processors to encode the current block based on the determined first control point motion vector and the second control point motion vector.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a block diagram illustrating an example video encoding and decoding system that may utilize one or more techniques described in this disclosure.

FIG. 2A illustrates spatial neighboring motion vector (MV) candidates for merge mode.

FIG. 2B illustrates spatial neighboring MV candidates for Advanced Motion Vector Prediction (AMVP) mode.

FIG. 3 illustrates two-point MV affine block with four affine parameters.

FIG. 4 illustrates neighboring blocks for affine inter mode.

FIGS. 5A and 5B illustrate candidates for AF_MERGE.

FIG. 6 illustrates an affine model with six parameters (three motion vectors).

FIG. 7 illustrates generating affine motion vectors from motion vectors of neighboring blocks.

FIG. 8 illustrates an example position of a generated affine merge candidate in a merge candidate list.

FIG. 9 is a block diagram illustrating an example video encoder that may implement one or more techniques described in this disclosure.

FIG. 10 is a block diagram illustrating an example video decoder that may implement one or more techniques described in this disclosure.

FIG. 11 is a flowchart illustrating an example method of operation in accordance with one or more example techniques described in this disclosure.

FIG. 12 is a flowchart illustrating an example method of operation in accordance with one or more example techniques described in this disclosure.

### DETAILED DESCRIPTION

This disclosure describes example techniques for generating control point motion vectors, also referred to as affine motion vectors. Control point motion vectors are used as part of affine motion prediction. In affine motion prediction, a video encoder and/or video decoder (commonly referred to as a video coder) determine control point motion vectors for control points. Therefore, control motion vectors may also be referred to as affine motion vectors. The control points are generally one or more corner points of a block being coded (e.g., encoded or decoded).

For affine motion prediction, from the control point motion vectors for the control points, the video coder determines motion vectors for sub-blocks within the block being coded. There is four-parameter affine and six-parameter affine coding. In four-parameter affine coding, the video coder determines control point motion vectors for two control points (e.g., determines two control point motion vectors), and the video coder determines the motion vectors for the sub-blocks from the control point motion vectors for the two control points. In six-parameter affine coding, the video coder determines control point motion vectors for three control points (e.g., determines three control point motion vectors), and the video coder determines the motion vectors for the sub-blocks from the control point motion vectors for the three control points.

This disclosure describes example techniques to determine the control point motion vectors for the control points (e.g., determine control point motion vectors). In particular, the disclosure describes example techniques to determine the control point motion vectors for the control points based on motion vectors of other previously coded blocks. The other previously coded blocks may be neighboring blocks, proximate blocks, or collocated blocks.

In one or more examples, for each control point, the video coder may determine a set of motion vectors (e.g., motion vectors of previously coded blocks). For instance, assume that for a four-parameter affine, the video coder is to determine a first control point motion vector for the top-left corner of the current block and is to determine a second control point motion vector for the top-right corner of the current block. In this example, for the top-left corner, the video coder may determine a first set of motion vectors (e.g., three motion vectors of three neighboring blocks to the top-left corner). For the top-right corner, the video coder may determine a second set of motion vectors (e.g., two motion vectors of two neighboring blocks to the top-right corner).

The video coder may select a motion vector from the first set of motion vectors as the first control point motion vector and select a motion vector from the second set of motion vectors as the second control point motion vector. In some examples, the video coder may select a motion vector from the first set of motion vectors as a first predictor for the first control point motion vector and select a motion vector from the second set of motion vectors as a second predictor for the second control point motion vector.

In both cases, in some examples, the video coder may select the motion vector from the first set of motion vectors and select the motion vector from the second set of motion vectors such that both of the selected motion vectors refer to the same reference picture. For instance, the video coder may determine to which reference picture a first motion vector in the first set of motion vectors points and determine if a motion vector in the second set of motion vectors points to the same reference picture. If the video coder determines that there are motion vectors in the first set of motion vectors and in the second set of motion vectors that point to the same reference picture, then the video coder may select these motion vectors as the first control point motion vector or a first predictor for the first control point motion vector and as the second control point motion vector or a second predictor for the second control point motion vector, respectively.

There may be other ways in which the video coder may select motion vectors that refer to the same reference picture. For instance, the video encoder may signal to the video decoder information that identifies a reference picture. In this example, the video decoder may evaluate motion vectors in the first set of motion vectors to identify a motion vector that points to the reference picture and evaluate motion vectors in the second set of motion vectors to identify a motion vector that points to the reference picture. In this example, the video decoder may set the two identified motion vectors as the first control point motion vector or a first predictor for the first control point motion vector and as the second control point motion vector or a second predictor for the second control point motion vector, respectively.

The example techniques described in this disclosure may provide technical solutions to technical problems and provide a practical application of the technical solutions. For instance, the example techniques described in this disclosure determine the control point motion vectors using motion information of previously coded blocks. Therefore, the amount of data the video encoder needs to signal is reduced. For instance, the video encoder does not need to signal information indicating the actual control point motion vectors. Rather, the video decoder can determine the control point motion vectors from motion vectors of previously coded blocks.

Furthermore, the video encoder may not need to signal any additional information (other than possibly a motion vector difference) that the video decoder needs to determine the control point motion vectors. For instance, the video decoder can determine to which reference pictures the motion vectors point and select the motion vectors accordingly without any additional information from the video encoder indicating which motion vectors to select from the sets of motion vectors. This further promotes reduction in signaling bandwidth.

Moreover, the criteria that motion vectors that the video coder selects point to the same reference picture reduces computations that the video coder needs to perform. For instance, if the motion vectors were to point to different reference pictures, the video coder would need to perform scaling operations so that the motion vectors are relative to the same picture. By ensuring that the motion vectors for the control points point to the same reference picture, the example techniques may reduce the computations that need to be performed, reducing how quickly the video decoder can reconstruct the current block.

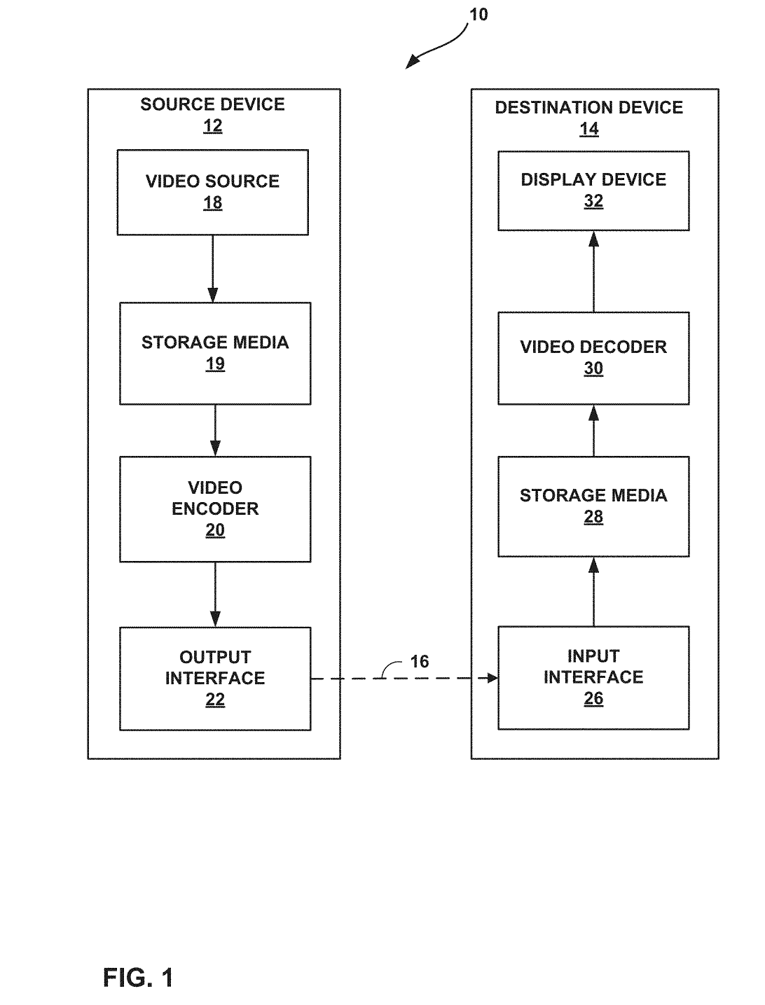

FIG. 1 is a block diagram illustrating an example video encoding and decoding system 10 that may utilize techniques of this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, tablet computers, televisions, cameras, display devices, digital media players, video gaming consoles, video streaming device, or the like. In some cases, source device 12 and destination device 14 may be equipped for wireless communication. Thus, source device 12 and destination device 14 may be wireless communication devices. Source device 12 is an example video encoding device (i.e., a device for encoding video data). Destination device 14 is an example video decoding device (i.e., a device for decoding video data).

In the example of FIG. 1, source device 12 includes a video source 18, storage media 19 configured to store video data, a video encoder 20, and an output interface 22. Destination device 14 includes an input interface 26, storage media 28 configured to store encoded video data, a video decoder 30, and display device 32. In other examples, source device 12 and destination device 14 include other components or arrangements. For example, source device 12 may receive video data from an external video source, such as an external camera. Likewise, destination device 14 may interface with an external display device, rather than including an integrated display device.

The illustrated system 10 of FIG. 1 is merely one example. Techniques for processing video data may be performed by any digital video encoding and/or decoding device. Although generally the techniques of this disclosure are performed by a video encoding device, the techniques may also be performed by a video encoder/decoder, typically referred to as a “CODEC.” Source device 12 and destination device 14 are merely examples of such coding devices in which source device 12 generates coded video data for transmission to destination device 14. In some examples, source device 12 and destination device 14 may operate in a substantially symmetrical manner such that each of source device 12 and destination device 14 include video encoding and decoding components. Hence, system 10 may support one-way or two-way video transmission between source device 12 and destination device 14, e.g., for video streaming, video playback, video broadcasting, or video telephony.

Video source 18 of source device 12 may include a video capture device, such as a video camera, a video archive containing previously captured video, and/or a video feed interface to receive video data from a video content provider. As a further alternative, video source 18 may generate computer graphics-based data as the source video, or a combination of live video, archived video, and computer-generated video. Source device 12 may comprise one or more data storage media (e.g., storage media 19) configured to store the video data. The techniques described in this disclosure may be applicable to video coding in general, and may be applied to wireless and/or wired applications. In each case, the captured, pre-captured, or computer-generated video may be encoded by video encoder 20. Output interface 22 may output the encoded video information to a computer-readable medium 16.

Output interface 22 may comprise various types of components or devices. For example, output interface 22 may comprise a wireless transmitter, a modem, a wired networking component (e.g., an Ethernet card), or another physical component. In examples where output interface 22 comprises a wireless receiver, output interface 22 may be configured to receive data, such as the bitstream, modulated according to a cellular communication standard, such as 4G, 4G-LTE, LTE Advanced, 5G, and the like. In some examples where output interface 22 comprises a wireless receiver, output interface 22 may be configured to receive data, such as the bitstream, modulated according to other wireless standards, such as an IEEE 802.11 specification, an IEEE 802.15 specification (e.g., ZigBee™), a Bluetooth™ standard, and the like. In some examples, circuitry of output interface 22 may be integrated into circuitry of video encoder 20 and/or other components of source device 12. For example, video encoder 20 and output interface 22 may be parts of a system on a chip (SoC). The SoC may also include other components, such as a general purpose microprocessor, a graphics processing unit, and so on.

Destination device 14 may receive the encoded video data to be decoded via computer-readable medium 16. Computer-readable medium 16 may comprise any type of medium or device capable of moving the encoded video data from source device 12 to destination device 14. In some examples, computer-readable medium 16 comprises a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14. Destination device 14 may comprise one or more data storage media configured to store encoded video data and decoded video data.

In some examples, encoded data may be output from output interface 22 to a storage device. Similarly, encoded data may be accessed from the storage device by input interface 26. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 26 of destination device 14 receives information from computer-readable medium 16. The information of computer-readable medium 16 may include syntax information defined by video encoder 20 of video encoder 20, which is also used by video decoder 30, that includes syntax elements that describe characteristics and/or processing of blocks and other coded units. Input interface 26 may comprise various types of components or devices. For example, input interface 26 may comprise a wireless receiver, a modem, a wired networking component (e.g., an Ethernet card), or another physical component. In examples where input interface 26 comprises a wireless receiver, input interface 26 may be configured to receive data, such as the bitstream, modulated according to a cellular communication standard, such as 4G, 4G-LTE, LTE Advanced, 5G, and the like. In some examples where input interface 26 comprises a wireless receiver, input interface 26 may be configured to receive data, such as the bitstream, modulated according to other wireless standards, such as an IEEE 802.11 specification, an IEEE 802.15 specification (e.g., ZigBee™), a Bluetooth™ standard, and the like. In some examples, circuitry of input interface 26 may be integrated into circuitry of video decoder 30 and/or other components of destination device 14. For example, video decoder 30 and input interface 26 may be parts of a SoC. The SoC may also include other components, such as a general purpose microprocessor, a graphics processing unit, and so on.

Storage media 28 may be configured to store encoded video data, such as encoded video data (e.g., a bitstream) received by input interface 26. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In some examples, video encoder 20 and video decoder 30 may operate according to a video coding standard such as an existing or future standard. Example video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

High-Efficiency Video Coding (HEVC) by the Joint Collaboration Team on Video Coding (JCT-VC) of ITU-T Video Coding Experts Group (VCEG) and ISO/IEC Motion Picture Experts Group (MPEG) is another example video coding standard. The latest HEVC draft specification, and referred to as HEVC WD hereinafter, is available from http://phenix.int-evey.fr/jct/doc_end_user/documents/15_Geneva/wg11/JCTVC-01003-v2.zip. The HEVC standard is published as ITU-T H.265, Series H: Audiovisual and Multimedia Systems, Infrastructure of audiovisual services—Coding of moving video, High efficiency video coding, Telecommunication Standardization Sector of International Telecommunication Union (ITU), April 2015.

The Range Extensions to HEVC, namely HEVC-Rext, are also developed by the JCT-VC. A Working Draft (WD) of Range extensions, referred to as RExt WD6 hereinafter, is available from http://phenix.int-evry.fr/j ct/doc_end_user/documents/16_San%20Jose/wg11/JCTVC-P1005-v1. zip.

Recently, investigation of new coding tools for future video coding are ongoing (studied in JVET—Joint Video Exploration Team), and technologies that improve the coding efficiency for video coding have been proposed. There is evidence that significant improvements in coding efficiency can be obtained by exploiting the characteristics of video content, especially for the high resolution content like 4K, with novel dedicated coding tools beyond H.265/HEVC.

For example, ITU-T VCEG (Q6/16) and ISO/IEC MPEG (JTC 1/SC 29/WG 11) are now studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. A version of the reference software, i.e., Joint Exploration Test Model 3 (JEM 3), could be downloaded from: https://jvet.hhi.fraunhofer.de/svn/svn_HMJEMSoftware/tags/HM-16.6-JEM-3.0/. A document, J. Chen, E. Alshina, G. J. Sullivan, J.-R. Ohm, J. Boyce, “Algorithm Description of Joint Exploration Test Model 3”, JVET-C1001, May, 2016 (hereinafter, “JVET-C1001”), includes an algorithm description of Joint Exploration Test Model 3 (JEM3). The groups of the JVET are developing the new video coding standard referred to as versatile video coding (VVC).

In HEVC and other video coding specifications, video data includes a series of pictures. Pictures may also be referred to as “frames.” A picture may include one or more sample arrays. Each respective sample array of a picture may comprise an array of samples for a respective color component. In HEVC, a picture may include three sample arrays, denoted S_{L}, S_{Cb}, and S_{Cr}. S_{L} is a two-dimensional array (i.e., a block) of luma samples. S_{Cb} is a two-dimensional array of Cb chroma samples. S_{Cr} is a two-dimensional array of Cr chroma samples. In other instances, a picture may be monochrome and may only include an array of luma samples.

As part of encoding video data, video encoder 20 may encode pictures of the video data. In other words, video encoder 20 may generate encoded representations of the pictures of the video data. An encoded representation of a picture may be referred to herein as a “coded picture” or an “encoded picture.”

To generate an encoded representation of a picture, video encoder 20 may encode blocks of the picture. Video encoder 20 may include, in a bitstream, an encoded representation of the video block. For example, to generate an encoded representation of a picture, video encoder 20 may partition each sample array of the picture into coding tree blocks (CTBs) and encode the CTBs. A CTB may be an N×N block of samples in a sample array of a picture. In the HEVC main profile, the size of a CTB can range from 16×16 to 64×64, although technically 8×8 CTB sizes can be supported.

A coding tree unit (CTU) of a picture may comprise one or more CTBs and may comprise syntax structures used to encode the samples of the one or more CTBs. For instance, each CTU may comprise a CTB of luma samples, two corresponding CTBs of chroma samples, and syntax structures used to encode the samples of the CTBs. In monochrome pictures or pictures having three separate color planes, a CTU may comprise a single CTB and syntax structures used to encode the samples of the CTB. A CTU may also be referred to as a “tree block” or a “largest coding unit” (LCU). In this disclosure, a “syntax structure” may be defined as zero or more syntax elements presented together in a bitstream in a specified order. In some codecs, an encoded picture is an encoded representation containing all CTUs of the picture.

To encode a CTU of a picture, video encoder 20 may partition the CTBs of the CTU into one or more coding blocks. A coding block is an N×N block of samples. In some codecs, to encode a CTU of a picture, video encoder 20 may recursively perform quad-tree partitioning on the coding tree blocks of a CTU to partition the CTBs into coding blocks, hence the name “coding tree units.” A coding unit (CU) may comprise one or more coding blocks and syntax structures used to encode samples of the one or more coding blocks. For example, a CU may comprise a coding block of luma samples and two corresponding coding blocks of chroma samples of a picture that has a luma sample array, a Cb sample array, and a Cr sample array, and syntax structures used to encode the samples of the coding blocks. In monochrome pictures or pictures having three separate color planes, a CU may comprise a single coding block and syntax structures used to code the samples of the coding block.

Furthermore, video encoder 20 may encode CUs of a picture of the video data. In some codecs, as part of encoding a CU, video encoder 20 may partition a coding block of the CU into one or more prediction blocks. A prediction block is a rectangular (i.e., square or non-square) block of samples on which the same prediction is applied. A prediction unit (PU) of a CU may comprise one or more prediction blocks of a CU and syntax structures used to predict the one or more prediction blocks. For example, a PU may comprise a prediction block of luma samples, two corresponding prediction blocks of chroma samples, and syntax structures used to predict the prediction blocks. In monochrome pictures or pictures having three separate color planes, a PU may comprise a single prediction block and syntax structures used to predict the prediction block.

Video encoder 20 may generate a predictive block (e.g., a luma, Cb, and Cr predictive block) for a prediction block (e.g., luma, Cb, and Cr prediction block) of a CU. Video encoder 20 may use intra prediction or inter prediction to generate a predictive block. If video encoder 20 uses intra prediction to generate a predictive block, video encoder 20 may generate the predictive block based on decoded samples of the picture that includes the CU. If video encoder 20 uses inter prediction to generate a predictive block of a CU of a current picture, video encoder 20 may generate the predictive block of the CU based on decoded samples of a reference picture (i.e., a picture other than the current picture).

In HEVC and particular other codecs, video encoder 20 encodes a CU using only one prediction mode (i.e., intra prediction or inter prediction). Thus, in HEVC and particular other codecs, video encoder 20 may generate predictive blocks of a CU using intra prediction or video encoder 20 may generate predictive blocks of the CU using inter prediction. When video encoder 20 uses inter prediction to encode a CU, video encoder 20 may partition the CU into 2 or 4 PUs, or one PU corresponds to the entire CU. When two PUs are present in one CU, the two PUs can be half size rectangles or two rectangle sizes with ¼ or ¾ size of the CU. In HEVC, there are eight partition modes for a CU coded with inter prediction mode, i.e., PART_2N×2N, PART_2N×N, PART_N×2N, PART_N×N, PART_2N×nU, PART_2N×nD, PART_nL×2N and PART_nR×2N. When a CU is intra predicted, 2N×2N and N×N are the only permissible PU shapes, and within each PU a single intra prediction mode is coded (while chroma prediction mode is signalled at CU level).

Video encoder 20 may generate one or more residual blocks for the CU. For instance, video encoder 20 may generate a luma residual block for the CU. Each sample in the CU's luma residual block indicates a difference between a luma sample in one of the CU' s predictive luma blocks and a corresponding sample in the CU' s original luma coding block. In addition, video encoder 20 may generate a Cb residual block for the CU. Each sample in the Cb residual block of a CU may indicate a difference between a Cb sample in one of the CU' s predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may decompose the residual blocks of a CU into one or more transform blocks. For instance, video encoder 20 may use quad-tree partitioning to decompose the residual blocks of a CU into one or more transform blocks. A transform block is a rectangular (e.g., square or non-square) block of samples on which the same transform is applied. A transform unit (TU) of a CU may comprise one or more transform blocks. For example, a TU may comprise a transform block of luma samples, two corresponding transform blocks of chroma samples, and syntax structures used to transform the transform block samples. Thus, each TU of a CU may have a luma transform block, a Cb transform block, and a Cr transform block. The luma transform block of the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

Video encoder 20 may apply one or more transforms to a transform block of a TU to generate a coefficient block for the TU. A coefficient block may be a two-dimensional array of transform coefficients. In some examples, the one or more transforms convert the transform block from a pixel domain to a frequency domain. Thus, in such examples, a transform coefficient may be considered to be in a frequency domain.

In some examples, video encoder 20 skips application of the transforms to the transform block. In such examples, video encoder 20 may treat residual sample values in the same way as transform coefficients. Thus, in examples where video encoder 20 skips application of the transforms, the following discussion of transform coefficients and coefficient blocks may be applicable to transform blocks of residual samples.

After generating a coefficient block, video encoder 20 may quantize the coefficient block. Quantization generally refers to a process in which transform coefficients are quantized to possibly reduce the amount of data used to represent the transform coefficients, providing further compression. In some examples, video encoder 20 skips quantization. After video encoder 20 quantizes a coefficient block, video encoder 20 may generate syntax elements indicating the quantized transform coefficients. Video encoder 20 may entropy encode one or more of the syntax elements indicating the quantized transform coefficients. For example, video encoder 20 may perform Context-Adaptive Binary Arithmetic Coding (CABAC) on the syntax elements indicating the quantized transform coefficients. Thus, an encoded block (e.g., an encoded CU) may include the entropy encoded syntax elements indicating the quantized transform coefficients.

Video encoder 20 may output a bitstream that includes encoded video data. In other words, video encoder 20 may output a bitstream that includes an encoded representation of video data. For example, the bitstream may comprise a sequence of bits that forms a representation of encoded pictures of the video data and associated data. In some examples, a representation of a coded picture may include encoded representations of blocks.

The bitstream may comprise a sequence of network abstraction layer (NAL) units. A NAL unit is a syntax structure containing an indication of the type of data in the NAL unit and bytes containing that data in the form of a raw byte sequence payload (RBSP) interspersed as necessary with emulation prevention bits. Each of the NAL units may include a NAL unit header and encapsulates a RBSP. The NAL unit header may include a syntax element indicating a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Video decoder 30 may receive a bitstream generated by video encoder 20. As noted above, the bitstream may comprise an encoded representation of video data. Video decoder 30 may decode the bitstream to reconstruct pictures of the video data. As part of decoding the bitstream, video decoder 30 may parse the bitstream to obtain syntax elements from the bitstream. Video decoder 30 may reconstruct pictures of the video data based at least in part on the syntax elements obtained from the bitstream. The process to reconstruct pictures of the video data may be generally reciprocal to the process performed by video encoder 20 to encode the pictures.

For instance, video decoder 30 may use inter prediction or intra prediction to generate one or more predictive blocks for each PU of the current CU may use motion vectors of PUs to determine predictive blocks for the PUs of a current CU. In addition, video decoder 30 may inverse quantize coefficient blocks of TUs of the current CU. Video decoder 30 may perform inverse transforms on the coefficient blocks to reconstruct transform blocks of the TUs of the current CU. In some examples, video decoder 30 may reconstruct the coding blocks of the current CU by adding the samples of the predictive blocks for PUs of the current CU to corresponding decoded samples of the transform blocks of the TUs of the current CU. By reconstructing the coding blocks for each CU of a picture, video decoder 30 may reconstruct the picture.

A slice of a picture may include an integer number of CTUs of the picture. The CTUs of a slice may be ordered consecutively in a scan order, such as a raster scan order. In HEVC, a slice is defined as an integer number of CTUs contained in one independent slice segment and all subsequent dependent slice segments (if any) that precede the next independent slice segment (if any) within the same access unit. Furthermore, in HEVC, a slice segment is defined as an integer number of coding tree units ordered consecutively in the tile scan and contained in a single NAL unit. A tile scan is a specific sequential ordering of CTBs partitioning a picture in which the CTBs are ordered consecutively in CTB raster scan in a tile, whereas tiles in a picture are ordered consecutively in a raster scan of the tiles of the picture. A tile is a rectangular region of CTBs within a particular tile column and a particular tile row in a picture.

As mentioned above, in HEVC, the largest coding unit in a slice is called a coding tree block (CTB) or coding tree unit (CTU). A CTB contains a quad-tree the nodes of which are coding units. The size of a CTB can range from 16×16 to 64×64 in the HEVC main profile (although technically 8×8 CTB sizes can be supported). A coding unit (CU) could be the same size of a CTB though and as small as 8×8. Each coding unit is coded with one mode. When a CU is inter coded, the CU may be further partitioned into 2 or 4 prediction units (PUs) or become just one PU when further partition does not apply. When two PUs are present in one CU, the PUs can be half size rectangles or two rectangle size with ¼ or ¾ size of the CU. When the CU is inter coded, one set of motion information is present for each PU. In addition, each PU is coded with a unique inter-prediction mode to derive the set of motion information.

In general, in H.265/HEVC, for each block, a set of motion information can be available. A set of motion information contains motion information for forward and backward prediction directions. Here, forward and backward prediction directions are two prediction directions of a bi-directional prediction mode and the terms “forward” and “backward” do not necessarily have a geometry meaning; instead they correspond to reference picture list 0 (RefPicList0) and reference picture list 1 (RefPicList1) of a current picture. When only one reference picture list is available for a picture or slice, only RefPicList0 is available and the motion information of each block of a slice is always forward.

For each prediction direction, the motion information may contain a reference index and a motion vector. In some cases, for simplicity, a motion vector itself may be referred in a way that it is assumed that it has an associated reference index. A reference index is used to identify a reference picture in the current reference picture list (RefPicList0 or RefPicList1). A motion vector has a horizontal and a vertical component.

Picture order count (POC) is widely used in video coding standards to identify a display order of a picture. Although there are cases where two pictures within one coded video sequence may have the same POC value, it typically does not happen within a coded video sequence. When multiple coded video sequences are present in a bitstream, pictures with a same value of POC may be closer to each other in terms of decoding order. POC values of pictures are typically used for reference picture list construction, derivation of reference picture set as in HEVC and motion vector scaling.

As described above, in HEVC, the largest coding unit in a slice is called a coding tree block (CTB). A CTB contains a quad-tree the nodes of which are coding units.

The size of a CTB can range from 16×16 to 64×64 in the HEVC main profile (although technically 8×8 CTB sizes can be supported). A coding unit (CU) could be the same size of a CTB although and as small as 8×8. Each coding unit is coded with one mode. When a CU is inter coded, it may be further partitioned into two prediction units (PUs) or become just one PU when further partition does not apply. When two PUs are present in one CU, they can be half size rectangles or two rectangle size with ¼ or ¾ size of the CU.

When the CU is inter coded, one set of motion information is present for each PU. In addition, each PU is coded with a unique inter-prediction mode to derive the set of motion information. In HEVC, the smallest PU sizes are 8×4 and 4×8.

In HEVC standard, there are two inter prediction modes, named merge (skip is considered as a special case of merge) and advanced motion vector prediction (AMVP) modes respectively for a prediction unit (PU). In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures are used for the prediction of the current blocks, as well as the associated motion vectors are determined. However, under AMVP mode for each potential prediction direction from either list 0 or list 1, a reference index needs to be explicitly signaled, together with an MVP index to the MV candidate list since the AMVP candidate contains only a motion vector. In AMVP mode, the predicted motion vectors can be further refined.

As can be seen above, a merge candidate corresponds to a full set of motion information while an AMVP candidate contains just one motion vector for a specific prediction direction and reference index. The candidates for both modes are derived similarly from the same spatial and temporal neighboring blocks.

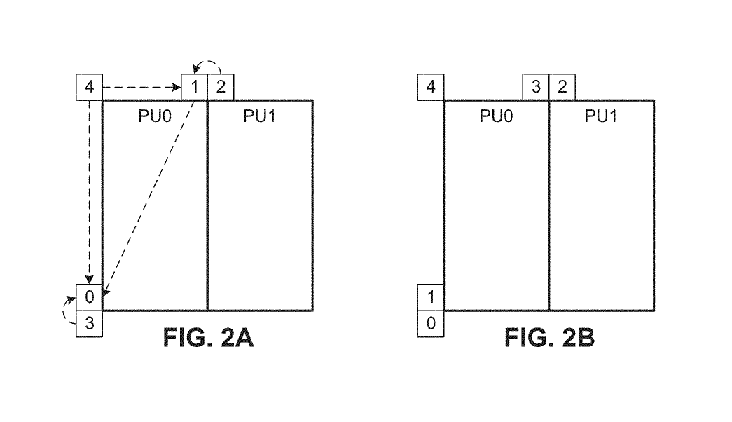

Spatial MV candidates are derived from the neighboring blocks shown in FIGS. 2A and 2B for a specific PU (PU₀), although the methods for generating the candidates from the blocks differ for merge and AMVP modes. In merge mode, up to four spatial MV candidates can be derived with the orders showed in FIG. 2A with numbers, and the order is the following: left (0), above (1), above right (2), below left (3), and above left (4), as shown in FIG. 2A. Pruning operations may be applied to remove identical MV candidates.

In AVMP mode, the neighboring blocks are divided into two groups: left group consisting of the block 0 and 1, and above group consisting of the blocks 2, 3, and 4 as shown in FIG. 2B. For each group, the potential candidate in a neighboring block referring to the same reference picture as that indicated by the signaled reference index has the highest priority to be chosen to form a final candidate of the group. It is possible that all neighboring blocks do not contain a motion vector pointing to the same reference picture. Therefore, if such a candidate cannot be found, the first available candidate will be scaled to form the final candidate; thus the temporal distance differences can be compensated.

As described above, motion compensation in H.265/HEVC is used to generate a predictor for the current inter-coded block. A quarter pixel accuracy motion vector is used and pixel values at fractional positions are interpolated using neighboring integer pixel values for both luma and chroma components.

In the current existing video codec standards, only a translational motion model is applied for motion compensation prediction (MCP), while in the real world, there are many kinds of motions, e.g. zoom in/out, rotation, perspective motions and the other irregular motions. If only a translation motion model for MCP is applied in such test sequences with irregular motions, the prediction accuracy is affected and results in low coding efficiency.

For many years, many video experts have tried to design algorithms to improve MCP for higher coding efficiency. Affine prediction is one example way to improve MCP. In affine prediction, a block is divided into a plurality of sub-blocks, and video encoder 20 and video decoder 30 determine motion vectors for each of the sub-blocks. The motion vectors for the sub-blocks may be based on motion vectors for control points. Examples of the control points are one or more corners of the block, but other points are possible options for control points.

An affine merge and affine inter modes are proposed to deal with affine motion models with 4 parameters such as the following:

$$\{ \begin{matrix}{mv}_{x} = ax - by + c \\ {mv}_{y} = bx + ay + d\end{matrix} \qquad 1 )$$

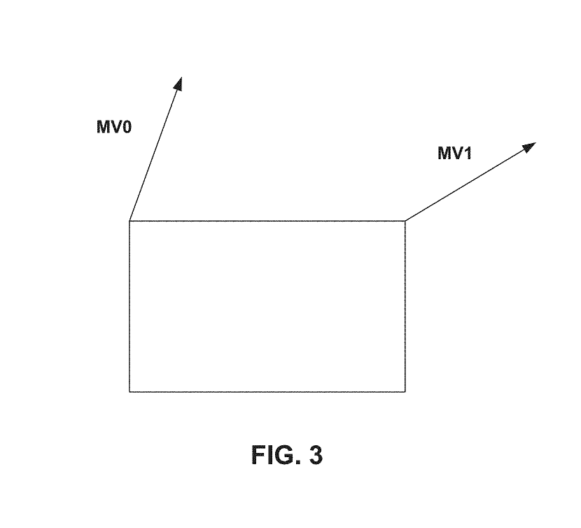

(vx₀,vy₀) is the control point motion vector on the top left corner, and (vx₁, vy₁) is another control point motion vector on the above right corner of the block as shown in FIG. 3 (e.g., MV0 is an example of (vx₀,vy₀) and MV1 is an example of (vx₁,vy₁). The affine model may be defined as follows

$$\{ \begin{matrix}{mv}_{x} = \frac{( {mv}_{1 x} - {mv}_{0 x} )}{w} x - \frac{( {mv}_{1 y} - {mv}_{0 y} )}{w} y + {mv}_{0 x} \\ {mv}_{y} = \frac{( {mv}_{1 y} - {mv}_{0 y} )}{w} x + \frac{( {mv}_{1 x} - {mv}_{0 x} )}{w} y + {mv}_{0 y}\end{matrix} \qquad 2 )$$

where w is the width of the block. Using equation (2), video encoder 20 and video decoder 30 may determine the motion vectors for the sub-blocks.

In the current JEM software, the affine motion prediction is only applied to a square block. As a natural extension, the affine motion prediction can be applied to non-square block. Similar to the conventional translation motion coding, two modes (i.e., inter mode with motion information signaled and merge mode with motion information derived) are supported for affine motion coding.

For affine inter mode, for every CU/PU whose size is equal to or larger than 16×16, AF_INTER mode can be applied as follows. If the current CU/PU is in AF_INTER mode, an affine flag in CU/PU level is signalled in the bitstream. An affine motion vector prediction (MVP) candidate list (e.g., control point MVP candidate list) with two candidates as {(MVP⁰₀, MVP⁰₀), (MVP¹₀, MVP¹₁)} is built. Rate-distortion cost is used to determine which of (MVP⁰₀, MVP⁰₁) or (MVP¹₀, MVP¹₁) is selected as the affine motion vector prediction of the current CU/PU. If (MVP^{x}₀, MVP^{x}₁) is selected, then MV₀ is coded with MVP'o as the prediction and MV₀ is coded with MVP^{x}₁ as the prediction. The index to indicate the position of the selected candidate in the list is signalled for the current block in the bit-stream.

In some examples, the construction procedure of the affine MVP candidate list is as follows.

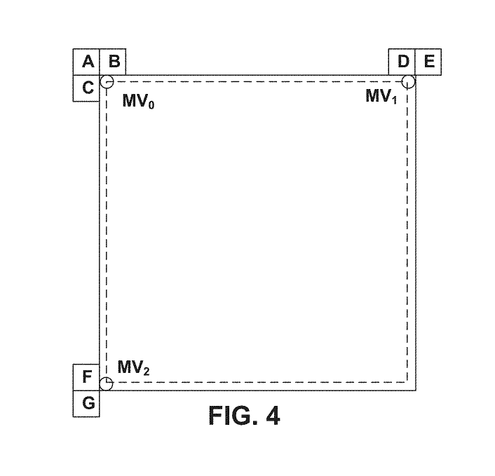

Collect MVs from three groups
Group G0: {MV-A, MV-B, MV-C}, group G1: {MV-D, MV-E}, group G2 {MV-F, MV-G}. Block A, B, C, D, E, F and G are shown in FIG. 4.
First take the one motion vector referring to the target reference picture.
Then take the scaling MVs if not referring to that (e.g., if none of the MVs refer to the target reference picture).

For a triple (MV0, MV1, MV2) from groups G0, G1, G2, derive a MV2′ from MV0 and MV1 with the affine model; then the following can be set D(MV0, MV1, MV2)=|MV2-MV2′|, where D refers to the difference between motion vectors.

Go through all triples from G0, G1 and G2, and find the triple (MV00, MV01, MV02) which produces the minimum D (difference), then set MVP⁰₀=MV00, MVP⁰₁=MV01.

If there are more than one available triple, find the (MV10, MV11, MV12) which produces the second minimum D, then set MVP¹₀=MV10, MVP¹₁=MV11.

If the candidates are not fulfilled, the MVP candidates for non-affine prediction block are derived for the current block. For example, the MVP candidates for non-affine prediction block are MVP_nonaff0 and MVP_nonaff1. If (MVP¹₀, MVP¹₁) cannot be found from the triple search, then set MVP¹₀=MVP¹₁=MVP_nonaff0.

After the MVP of the current affine CU/PU is determined, affine motion estimation is applied and the (MV⁰₀, MV⁰₁) is found. Then, the difference of (MV⁰₀, MV⁰₁) and (MVP^{x}₀, MVP^{x}₁) is coded in the bit stream.

Affine motion compensation prediction mentioned above is applied to generate the residues of the current CU/PU. Finally, the residues of the current CU/PU are transformed, quantized, and coded into the bit stream as the traditional procedure.

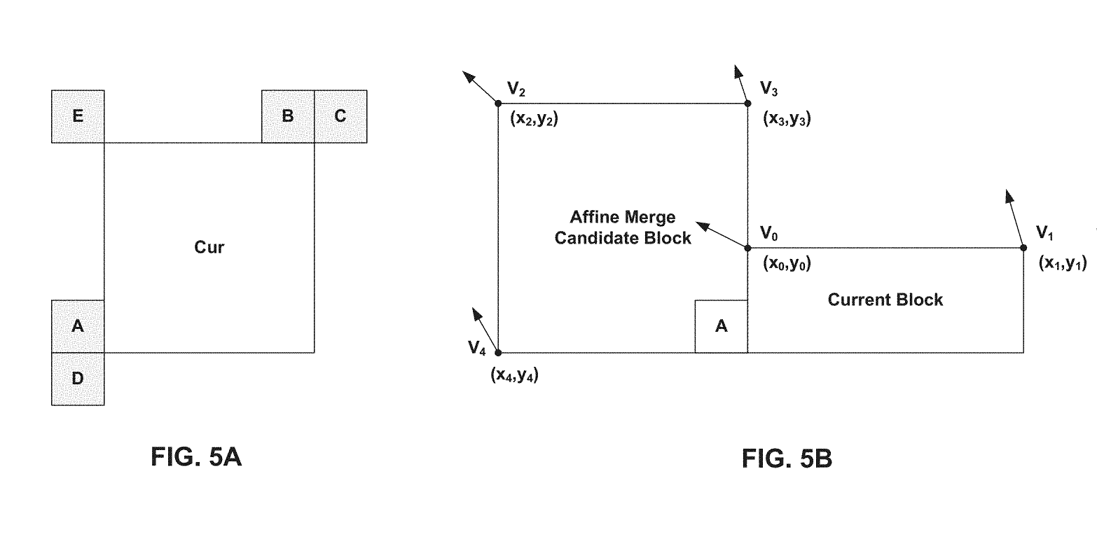

For affine merge mode, when the current CU/PU is applied in AF_MERGE mode, it gets the first block coded with affine mode from the valid neighbor reconstructed blocks, and the selection order for the candidate block is from left, above, above right, left bottom to above left as shown in FIG. 5A. For example, if the neighbour left bottom block A is coded in affine mode as shown in FIG. 5B, the motion vectors v₂, v₃, and v₄ of the top left corner, above right corner and left bottom corner of the CU/PU which contains the block A are derived. The motion vector v₀ of the top left corner on the current CU/PU is calculated based on v₂, v₃, and v₄. Similarly, the motion vector v₁ of the above right of the current CU/PU is calculated based on v₂, v₃, and v₄.

After the CPMV (control point motion vector) of the current CU/PU v₀ and v₁ are achieved, according to the simplified affine motion model defined in equation (2), the MVF (motion vector field) of the current CU/PU is generated. Then, Affine MCP is applied as described above (e.g., the motion vector field is the motion vectors of the sub-blocks, and the motion vectors of the sub-blocks identify reference blocks whose difference is used to encode or decode the sub-blocks).

In order to identify whether the current CU/PU is coded with AF_MERGE mode, an affine flag is signalled in the bit stream when there is at least one neighbor block coded in affine mode. If no affine block neighboring the current block exists as shown in FIG. 5A, no affine flag is written in the bit stream.

To indicate the affine merge mode, one affine flag is signaled if the merge flag is 1. If affine_flag is 1, the current block is coded with the affine merge mode, and no merge index is signaled. If affine_flag is 0, the current block is coded with the normal merge mode, and a merge index is signaled as follows. The table below shows the syntax design.

| | |
|---|---|
| merge_flag | Ae |
| if( merge_flag){ | |

| | |
|---|---|
| affine_flag | Ae |
| if(!affine_flag) | |

| | |
|---|---|
| merge_index | Ae |

}

In HEVC, context-adaptive binary arithmetic coding (CABAC) is used to convert a symbol into a binarized value. This process is called binarization. Binarization enables efficient binary arithmetic coding via a unique mapping of non-binary syntax elements to a sequence of bits, which are called bins.

In JEM 2.0 (or JEM 3.0) reference software, for affine merge mode, only the affine flag is coded, and the merge index is inferred to be the first available neighboring affine model in the predefined checking order A-B-C-D-E as shown in FIG. 5A.

For the affine inter mode, two MVD syntaxes are coded for each prediction list indicating the motion vector difference between derived affine motion vector (e.g., control point motion vector) and predicted motion vector.

The following describes four-parameter (two motion vectors) affine coding and six-parameter (three motion vectors) affine coding. In U.S. application Ser. Nos. 15/587,044, filed May 4, 2017, and 62/337,301, filed May 5, 2016, a switchable affine motion prediction scheme is proposed. U.S. application Ser. No. 15/587,044 published as U.S. Patent Publication No. 2017/0332095. A block with affine prediction can choose to use four-parameter affine model coding or six-parameter affine model coding adaptively.

An affine model with 6 parameters is defined as

$$\{ \begin{matrix}{mv}_{x} = ax + by + e \\ {mv}_{y} = cx + dy + f\end{matrix} \qquad 3 )$$

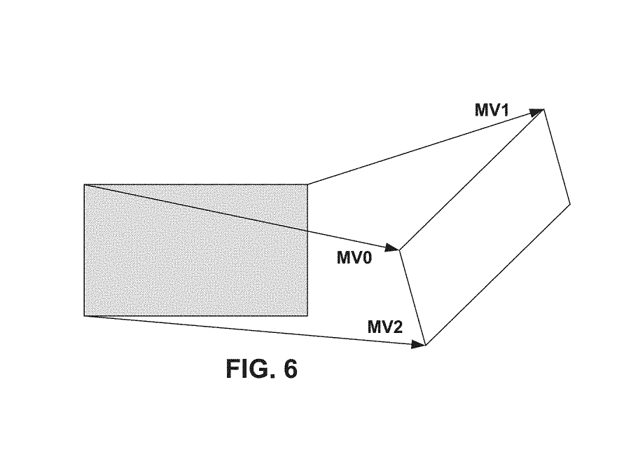

An affine model with 6 parameters has three control points. In other words, an affine model with 6 parameters is determined by three motion vectors as shown in FIG. 6. MV0 is the first control point motion vector on the top left corner, MV1 is the second control point motion vector on the above right corner of the block, and MV2 is the third control point motion vector on the left bottom corner of the block, as shown in FIG. 6. The affine model built with the three motion vectors is calculated as

$$\{ \begin{matrix}{mv}_{x} = \frac{( {mv}_{1 x} - {mv}_{0 x} )}{w} x + \frac{( {mv}_{2 x} - {mv}_{0 x} )}{h} y + {mv}_{0 x} \\ {mv}_{y} = \frac{( {mv}_{1 y} - {mv}_{0 y} )}{w} x + \frac{( {mv}_{2 y} - {mv}_{0 y} )}{h} y + {mv}_{0 y}\end{matrix} \qquad 4 )$$

There are more motion vector prediction methods for affine. An approach similar to affine-merge to derive the motion vectors of the top left corner and the above right corner as described above for affine merge mode can also be used to derive the MVPs for the top left corner, the above right corner and the below left corner. U.S. application Ser. Nos. 15/725,052, filed Oct. 4, 2017, and 62/404,719, filed Oct. 5, 2016 relate to deriving MVPs. U.S. application Ser. No. 15/725,052 published as U.S. Patent Publication No. 2018/0098063.

MVD1 can be predicted from MVD in the affine mode. U.S. Application Ser. No. 62/570,417, filed Oct. 10, 2017 and U.S. application Ser. No. 16/155,744, filed Oct. 9, 2018, relates to affine prediction in video coding, such as predicting MVD1 from MVD in affine mode.

Affine merge and normal merge can be unified. An affine merge candidate can be added into the merge candidate list. U.S. Application Ser. No. 62/586,117, filed Nov. 14, 2017 and U.S. application Ser. No. 16/188,774, filed Nov. 13, 2018, relates to an affine merge candidate being added into a merge candidate list. U.S. application Ser. No. 62/567,598, filed Oct. 3, 2017 and U.S. application Ser. No. 16/148,738, filed Oct. 1, 2018, is related to coding affine prediction motion information.

This disclosure describes techniques to generate control point motion vectors (e.g., affine motion vectors) from motion vectors of spatial blocks (e.g., neighboring blocks) and temporal blocks. Spatial blocks refer to blocks in the same picture as the current block being encoded or decoded. Temporal blocks refer to blocks in a different picture than the picture that includes the current block being encoded or decoded. In some examples, a temporal block may be a collocated block. A collocated block is a block located in the same relative position in its picture as the position of the current block in its picture.

The following techniques may be applied individually. Alternatively, any combination of them may be applied. For ease of reference, the techniques are described with respect to a video coder performing the example operations. One example of a video coder is video encoder 20, and another example is video decoder 30. Hence, “video coder” is used to generically refer to video encoder 20 and/or video decoder 30. Similarly, the term “code” is used to generically refer to encode, when performed by video encoder 20, or decode, when performed by video decoder 30.

As described above, and with respect to FIG. 3, there may be various ways in which to determine affine motion vectors for the control points. However, there may be technical problems associated with such techniques. For example, scaling may be required if the motion vectors do not refer to the same reference picture. Also, there may be various computations that are required, such as going through all triples from G0, G1, and G2 to find triple (MV00, MV01, MV02) which produces the minimum D (e.g., difference), as described above with respect to FIG. 3.

Such techniques may require additional signaling overhead and/or may require computations that can negatively impact the amount of time it takes to encode or decode the current block. This disclosure describes example techniques to quickly and efficiently determine control point motion vectors (e.g., motion vectors for the control points) that minimize signaling bandwidth and reduces computations.

For instance, the video coder may determine the control point motion vectors based on motion vectors of previously coded blocks. In some examples, the video coder determines a set of motion vectors for each control point. For instance, assume that a current block includes three control points: top-left, top-right, and bottom-left. The control point motion vector for the top-left control point is referred to as MV0. The control point motion vector for the top-right control point is referred to as MV1. The control point motion vector for the bottom-left control point is referred to as MV2.

In some examples, the video coder may determine a first set of motion vectors for MV0. The first set of motion vectors includes MVA, MVB, and MVC. MVA, MVB, and MVC may be motion vectors of previously coded blocks. The previously coded blocks may be spatially neighboring blocks that neighbor the top-left corner or blocks in the same slice or picture as the current block, but that do not necessarily neighbor the current block. It may be possible for the previously coded blocks to neighbor the current block. In some examples, one or more of MVA, MVB, or MVC may be motion vectors for a temporal block.

Similarly, the video coder may determine a second set of motion vectors for MV1. The second set of motion vectors includes MVD and MVE and may be motion vectors of previously coded spatial or temporal blocks. The video coder may also determine a third set of motion vectors for MV2. The third set of motion vectors includes MVF and MVG and may be motion vectors of previously coded spatial or temporal blocks.

In the above, the first, second, and third sets of motion vectors are provided for illustration purposes only and should not be considered limiting. There may be more or fewer motion vectors in the first, second, and third sets of the motion vectors. Also, in some examples, the motion vectors in the first, second, and third sets of motion vectors may be from different blocks. For instance, the blocks used to determine the motion vectors in the first set of motion vectors are different than the blocks used to determine the motion vectors in the second set of motion vectors and are different than the blocks used to determine the motion vectors in the third set of motion vectors.

The video coder may be configured to determine whether any of the motion vectors in the first, second, and third sets of motion vectors point to the same reference picture. For example, the video coder may determine the reference picture to which motion vector MVA points. The video coder may determine whether there is a motion vector in the second set of motion vectors that points to the same reference picture as MVA. Assume that MVE, in the second set of motion vectors, points to the same reference picture as MVA. The video coder may determine whether there is a motion vector in the second set of motion vectors that points to the same reference pictures as MVA and MVE. Assume that MVF, in the third set of motion vectors, points to the same reference picture as MVA and MVE.

In this example, because MVA, MVE, and MVF all point to the same reference picture, the video coder may select MVA, MVE, and MVF. In one example, the video coder may set MV0 (e.g., first control point motion vector) equal to MVA, set MV1 (e.g., the second control point motion vector) equal to MVE, and set MV2 (e.g., the third control point motion vector) equal to MVF.

In one example, the video coder may set MVA as a predictor for MV0. In this example, the video coder may determine MV0 as MVA plus a first MVD. The first MVD is a value signaled by video encoder 20 to video decoder 30 that indicates the difference between MV0 and MVA. By adding MVA plus the first MVD, video decoder 30 may determine the MV0. Similarly, the video coder may set MVE as a predictor for MV1, and the video coder may determine MV1 as MVE plus a second MVD. The second MVD is a value signaled by video encoder 20 to video decoder 30 that indicates the difference between MV1 and MVE. By adding MVE plus the second MVD, video decoder 30 may determine the MV1. Also, the video coder may set MVF as the predictor for MV2, and the video coder may determine MV2 as MVF plus a third MVD. The third MVD is a value signaled by video encoder 20 to video decoder 30 that indicates the difference between MV2 and MVF. By adding MVF plus the third MVD, video decoder 30 may determine the MV2.

In the above example, the video coder started with MVA and determines whether motion vectors in the second and third sets of motion vectors include a motion vector pointing to the same reference picture. In some examples, if the video coder determines that there are no motion vectors in second and third sets of motion vectors that include a motion vector pointing to the same reference picture as MVA, the video coder may then proceed with MVB and repeat these operations until the video coder determines motion vectors from each set of motion vectors that all point to the same reference picture.

In the event that there is no motion vector, in each of the sets of motion vectors, that points to the same reference picture, video encoder 20 may determine that affine motion prediction is not available for the current block. In this example, video encoder 20 may not signal information indicating that affine motion prediction is enabled for the current block, and video decoder 30 may not perform the example operations. Accordingly, in some non-limiting examples, affine motion prediction may only be enabled if there exists motion vectors in each of the first, second, and third sets of motion vectors that point to the same reference picture.

In the above examples, MVA, MVB, and MVC formed the motion vectors for the first set of motion vectors. Assume that MVA is for block A, MVB is for block B, and MVC is for block C. In some examples, video encoder 20 and video decoder 30 may be pre-configured with information indicating the locations of blocks A, B, and C from which MVA, MVB, and MVC are used. The same would apply to MVD and MVE for the second set of motion vectors, and MVF and MVG for the third set of motion vectors.

The use of three sets of motion vectors may be applicable when six-parameter affine coding is enabled. For instance, video encoder 20 may signal information to video decoder 30 indicating whether six-parameter or four-parameter affine coding is enabled. If video decoder 30 determines that six-parameter affine coding is enabled, video decoder 30 may determine MV1, MV2, and MV3 using the example techniques described above.

If, however, video decoder 30 determines that four-parameter affine coding is enabled, then video decoder 30 may determine a first set of motion vectors and a second set of motion vectors, and not determine a third set of motion vectors because four-parameter affine uses only two control points. The video coder may perform the same operations as described above for MV1, MV2, and MV3, but only determine MV1 and MV2 (e.g., identify motion vectors in the first and second sets of motion vectors that point to the same reference picture). Again, six-parameter affine coding uses three control points, and therefore, there are three control point motion vectors, i.e., one control point motion vector for each control point. Four-parameter affine coding uses two control points, and therefore, there are two control point motion vectors, i.e., one control point motion vector for each control point.

The above describes one example way in which the video coder may determine that the motion vectors from the sets of motion vectors point to the same reference picture. As another example, video encoder 20 may signal information identifying a reference picture. For example, video encoder 20 may signal a reference index into RefPicList0 or RefPicList1.

In this example, video decoder 30 may determine the reference picture based on the signaled information. For six-parameter affine, video decoder 30 may then determine whether any of the motion vectors in the first set of motion vectors point to the determined reference picture, determine whether any of the motion vectors in the second set of motion vectors point to the determined reference picture, and determine whether any of the motion vectors in the third set of motion vectors point to the determined reference picture. For four-parameter affine, there may be two sets of motion vectors, rather than three. Video decoder 30 may identify a motion vector in each of the sets of motion vectors (again, two sets for four-point affine and three sets for six-point affine) that each point to the determined reference picture.

Similar to above, in one example, video decoder 30 may set the identified motion vectors from respective sets of motion vectors as the control point motion vectors for the corresponding control points. In one example, video decoder 30 may set the identified motion vectors as motion vector predictors and add the respective motion vector differences (as signaled by video encoder 20) to the motion vector predictors to determine the control point motion vectors for the corresponding control points.

To summarize, a video coder may generate the affine motion vectors (e.g., control point motion vectors) of a block from motion vectors of its spatial neighboring blocks (e.g., determine the sets of motion vectors from blocks that are spatially neighboring). In one example, the spatial neighboring blocks may be defined as those which are located next to the current block. Alternatively, or furthermore, the spatial neighboring blocks are defined as those utilized in the merge and/or AMVP candidate list construction blocks.

In another example, the spatial neighboring blocks may be defined as those which are not next to the current block, but still in the same slice/tile/picture. In one example, the two corner motion vectors (MV0, MV1) of one block as shown in FIG. 3 are generated from motion vectors of its spatial neighboring blocks. For instance, the first set of motion vectors are from blocks that neighbor the top-left corner and MV0 is determined from the first set of motion vectors, and the second set of motion vectors are from blocks that neighbor the top-right corner and MV1 is determined from the second set of motion vectors. In another example, the three corner motion vectors (MV0, MV1, MV2) of one block as shown in FIG. 6 are generated from motion vectors of its spatial neighboring blocks. For instance, the first set of motion vectors are from blocks that neighbor the top-left corner and MV0 is determined from the first set of motion vectors, the second set of motion vectors are from blocks that neighbor the top-right corner and MV1 is determined from the second set of motion vectors, and the third set of motion vectors are from blocks that neighbor the bottom-left corner and MV2 is determined from the third set of motion vectors.

In one example, the generated affine motion vectors (e.g., control point motion vectors) are treated as an AMVP candidate for the current block with the affine merge mode. For instance, as described above, the video coder may determine that the motion vectors identified in the first, second, and third sets (for six-parameter affine) or just the first and second sets (for four-parameter affine) of the motion vectors are predictors to which respective motion vector differences are added to determine MV0, MV1, and MV2 (as appropriate for six-parameter or four-parameter affine).

In one example, the generated affine motion vectors (e.g., control point motion vectors) are treated as a merge candidate for the current block with the affine merge mode. For example, as described above, the video coder may set the MV0, MV1, and MV2 (as appropriate for six-parameter or four-parameter affine) motion vectors equal to the identified motion vectors in the first, second, and third sets of motion vectors, respectively, that pointed to the same reference picture.

In another example, the generated affine motion vectors (e.g., control point motion vectors) are treated as an affine merge candidate for the current block with the merge mode if the normal merge mode and affine merge mode are unified as described in U.S. Application Ser. No. 62/586,117, filed Nov. 14, 2017 and U.S. application Ser. No. 16/188,774, filed Nov. 13, 2018. In one example, there can be more than one affine merge candidate generated for the current block from motion vectors of its spatial neighboring blocks.

Multiple neighboring blocks may be classified into several groups, and each control point may be derived from one of the groups. Alternatively or additionally, parts of control points may be generated from the neighboring blocks and the remaining control points may be derived from the generated derived control points. In other words, as described above, the video coder may determine a set of motion vectors for each of the control points, and determine the motion vector for each of the corresponding control points from the motion vectors in the corresponding set of motion vectors.

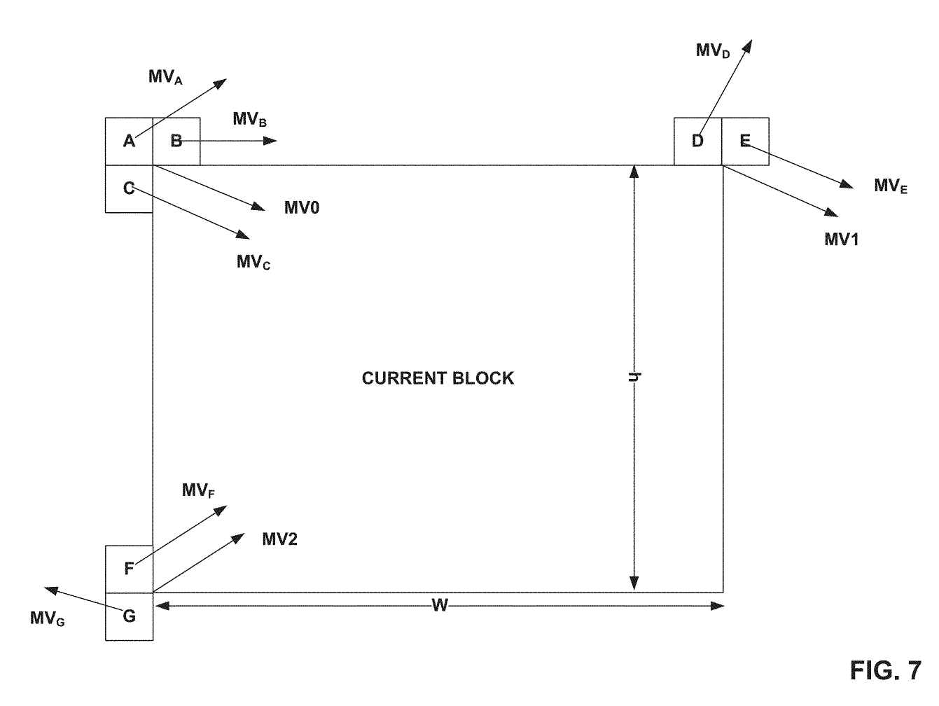

In one example, as shown in FIG. 7, motion vectors of neighboring blocks A, B, C, D, E, F and G are MVA, MVB, MVC, MVD, MVE, MVF and MVG, respectively. A neighboring block can be with any predefined size such as 4×4. The current block size is w×h. MV0(mv0ₓ, mv0_{y}) is set equal to one of MVA, MVB and MVC, namely MVX, if at least one of them exists (and assuming points to the same reference picture as MVs in the other sets); MV1(mv1ₓ, mv1_{y}) is set equal to one of MVD and MVE namely MVY, if at least one of them exists (and assuming points to the same reference picture as MVs in the other sets); and MV2(mv2ₓ, mv2_{y}) is set equal to one of MVF and MVG, namely MVZ, if at least one of them exists (and assuming points to the same reference picture as MVs in the other sets). MVX, MVY, and MVZ may, and in some examples must, refer to the same reference picture (“same” reference pictures are with the same reference list and the same reference index; or with the same reference picture POC). Based on the above assumption, the following may further apply.

In other words, FIG. 7 illustrates an example where for the top-left corner (e.g., first control point), the first set of motion vectors include vectors MVA, MVB, and MVC, where MVA is the motion vector for block A, MVB is the motion vector for block MVB, and MVC is the motion vector for block C. The video coder may select one of MVA, MVB, and MVC, and the selected one is referred to as MVX. The video coder may select MVA, MVB, or MVC based on one of them pointing to the same reference picture as a motion vector from the respective other sets. Similarly, for the top-right corner (e.g., second control point), the second set of motion vectors include vectors MVD and MVE, where MVD is the motion vector for block D and MVE is the motion vector for block E. The video coder may select one of MVD and MVE, and the selected one is referred to as MVY. The video coder may select MVD or MVE based on one of them pointing to the same reference picture as a motion vector from the respective other sets. For the bottom-left corner (e.g., third control point for six-parameter affine), the third set of motion vectors include vectors MVF and MVG, where MVF is the motion vector for block F and MVG is the motion vector for block G. The video coder may select MVF or MVG based on one of them pointing to the same reference picture as a motion vector from the respective other sets. The video coder may select one of MVF and MVG, and the selected one is referred to as MVZ.

The video coder may select the motion vectors from respective sets of motion vectors such that MVX, MVY, and MVZ all point to the same reference picture. In this way, the video coder may identify motion vectors from sets of motion vectors that point to the same reference picture. The video coder may set the control point motion vectors equal to the identified motion vectors (e.g., MV0 equals MVX, MV1 equals MVY, and MV2 equals MVZ). In some examples, MVX, MVY, and MVZ may be motion vector predictors. For instance, the video coder may determine MV0 as MVX plus a first motion vector difference, determine MV1 as MVY plus a second motion vector difference, and determine MV2 as MVZ plus a third motion vector difference.

For example, in one example, if there exists a MVX in {MVA, MVB, MVC}, a MVY in {MVD, MVE}, a MVZ in {MVF, MVG} and MVX, MVY, MVZ refer (e.g., point) to the same reference picture, and MV0, MV1, MV2 are the corner motion vectors of the current block with the 6-parameter affine model, then MV0, MV1 and MV2 can be set equal to MVX, MVY, and MVZ, respectively, and they all refer to the same reference picture as MVX, MVY, and MVZ refer to. As another example, MVX, MVY, and MVZ may be motion vector predictors.

In one example, if there exist a MVX in {MVA, MVB, MVC}, a MVY in {MVD, MVE} and MVX, MVY refer to the same reference picture, and MV0, MV1 are the corner motion vectors of the current block with the 6-parameter affine model, then MV0, MV1 can be set equal to MVX and MVY, respectively, and MV2 (mv2ₓ, mv2_{y}) can be calculated as

$$\{ \begin{matrix}mv {2}_{x} = - \frac{( {mv}_{1 y} - {mv}_{0 y} )}{w} h + {mv}_{0 x} \\ mv {2}_{y} = \frac{( {mv}_{1 x} - {mv}_{0 x} )}{w} h + {mv}_{0 y}\end{matrix}$$

MV0, MV1, MV2 all refer to the same reference picture as MVX and MVY.

In one example, if there exist a MVX in {MVA, MVB, MVC}, and a MVZ in {MVF, MVG} and MVX, MVY refer to the same reference picture, and MV0, MV1, MV2 are the corner motion vectors of the current block with the 6-parameter affine model, then MV0 and MV2 can be set equal to MVX, MVY and MVZ, respectively. In this example, MV1 (mv1ₓ, mv1_{y}) is calculated as

$$\{ \begin{matrix}mv {1}_{x} = \frac{( {mv}_{2 y} - {mv}_{0 y} )}{h} w + {mv}_{0 x} \\ mv {1}_{y} = - \frac{( {mv}_{2 x} - {mv}_{0 x} )}{h} w + {mv}_{0 y}\end{matrix}$$

MV0, MV1, MV2 all refer to the same reference picture as MVx and MVY.

In one example, MV0, MV1 and MV2, which are the corner motion vectors of the current block with the 6-parameter affine model, can be derived in a cascade way. For example, if MVX, MVY, MVZ, as described above, can be found, then MV0, MV1, MV2 are derived as described above. Otherwise (MVX, MVY, MVZ described above cannot be found), if MVX, MVY can be found as described above (e.g., where MV2 is calculated and MVX and MVY refer to the same picture), then MV0, MV1, MV2 are derived as described above. Otherwise (MVX, MVY, MVZ cannot be found and MVX, MVY cannot be found), if MVX, MVZ can be found as described above (e.g., where MV1 is calculated MVX and MVZ refer to the same picture), then MV0, MV1, MV2 are derived as described above. Otherwise (MVX, MVY, MVZ cannot be found, MVX, MVY cannot be found, and MVX, MVZ cannot be found), then control point motion vectors cannot be generated from motion vectors of neighboring blocks.

In one example, if there exists a MVX in {MVA, MVB, MVC}, a MVY in {MVD, MVE} and MVX, MVY refer to the same reference picture, and MV0, MV1 are the corner motion vectors of the current block with the 4-parameter affine model, then MV0, MV1 can be generated as MVX and MVY, respectively, and they all refer to the same reference picture as MVX and MVY.

In one example, if there exist a MVX in {MVA, MVB, MVC}, and a MVZ in {MVF, MVG} and MVX, MVZ refer to the same reference picture, and MV0, MV1, MV2 are the corner motion vectors of the current block with the 4-parameter affine model or 6-parameter affine model, then MV0 and MV2 can be set equal to MVX, MVY and MVZ, respectively, and MV1 (mv1ₓ, mv1_{y}) can be calculated as

$$\{ \begin{matrix}mv {1}_{x} = \frac{( {mv}_{2 y} - {mv}_{0 y} )}{h} w + {mv}_{0 x} \\ mv {1}_{y} = - \frac{( {mv}_{2 x} - {mv}_{0 x} )}{h} w + {mv}_{0 y}\end{matrix}$$

Multiple control points may be derived in a cascade way. For example, MV0, MV1 and MV2 which are the corner motion vectors of the current block with the 4-parameter affine model can be derived in a cascade way. For example, if MVX, MVY can be found, then MV0, MV1 is derived as described above. Otherwise (MVX, MVY) cannot be found), if MVX, MVZ can be found then MV0, MV1 is derived as described above. Otherwise (MVX, MVY cannot be found, MVX, and MVZ cannot be found), then control point motion vectors cannot be generated from motion vectors of neighboring blocks.

If there exists more than one group of MVX, MVY and MVZ satisfying the requirement described above (e.g., all refer to the same reference picture), the group of MVX, MVY and MVZ which refers to a reference picture with the minimum reference index value can be chosen. MV0, MV1 and MV2 can be derived as described above with the chosen MVX, MVY and MVZ, and they all refer to the reference picture with the minimum reference index.

If there exists more than one group of MVX and MVY satisfying the requirement described above (e.g., all refer to the same reference picture), the group of MVX and MVY which refers to a reference picture with the minimum reference index value can be chosen. MV0, MV1 and MV2 can be derived as described above with the chosen MVX and MVY, and they all refer to the reference picture with the minimum reference index value.

If there exist more than one group of MVX and MVZ satisfying the requirement described above (e.g., all refer to the same reference picture), the group of MVX and MVZ which refers to a reference picture with the minimum reference index value can be chosen. MV0, MV1 and MV2 can be derived as described above with the chosen MVX and MVZ, and they all refer to the reference picture with the minimum reference index value.

If there exist more than one group of MVX and MVY satisfying the requirement described above (e.g., all refer to the same reference picture), the group of MVX and MVY which refers to a reference picture with the minimum reference index value can be chosen. MV0 and MV1 can be derived as described above with the chosen MVX and MVY, and they all refer to the reference picture with the minimum reference index value.

If there exist more than one group of MVX and MVZ satisfying the requirement described above (e.g., all refer to the same reference picture), the group of MVX and MVZ which refers to a reference picture with the minimum reference index value can be chosen. MV0 and MV1 can be derived as described above with the chosen MVX and MVZ, and they all refer to the reference picture with the minimum reference index value.

If the generated control points have the same motion information, this affine motion candidate may be treated as unavailable. In other words, the generated candidate may not be added to the candidate list (either AMVP or merge candidate list). For example, for a block with the 6-parameter affine model, if the generated MV0=MV1=MV2, then the generated affine motions can be regarded as unavailable. Similarly, for a block with the 4-parameter affine model, if the generated MV0=MV1, then the generated affine motions can be regarded as unavailable.

The two reference lists can be processed individually. For example, List0 (e.g., RefPicList0) is checked first followed by List1 (e.g., RefPicList1). If MVX, MVY and MVZ referring to the same reference picture in List0 (i.e., the same reference index in List0) can be found, then affine corner motion vectors MV0, MV1 and MV2 for List0 can be generated. If MVX, MVY and MVZ referring to the same reference picture in List1 (i.e., the same reference index in List0) can be found, then affine corner motion vectors MV0, MV1 and MV2 for List1 can be generated. If MV0, MV1 and MV2 for only one list can be found, then the generated affine motion vectors (e.g., control point motion vectors) are used in uni-prediction motion compensation. If MV0, MV1 and MV2 for both of the two lists can be found, then the generated affine motion vectors are used in bi-prediction motion compensation.

Pruning may be further applied wherein the generated affine candidate is reset to be unavailable if it is identical with any of other previously added affine candidates.

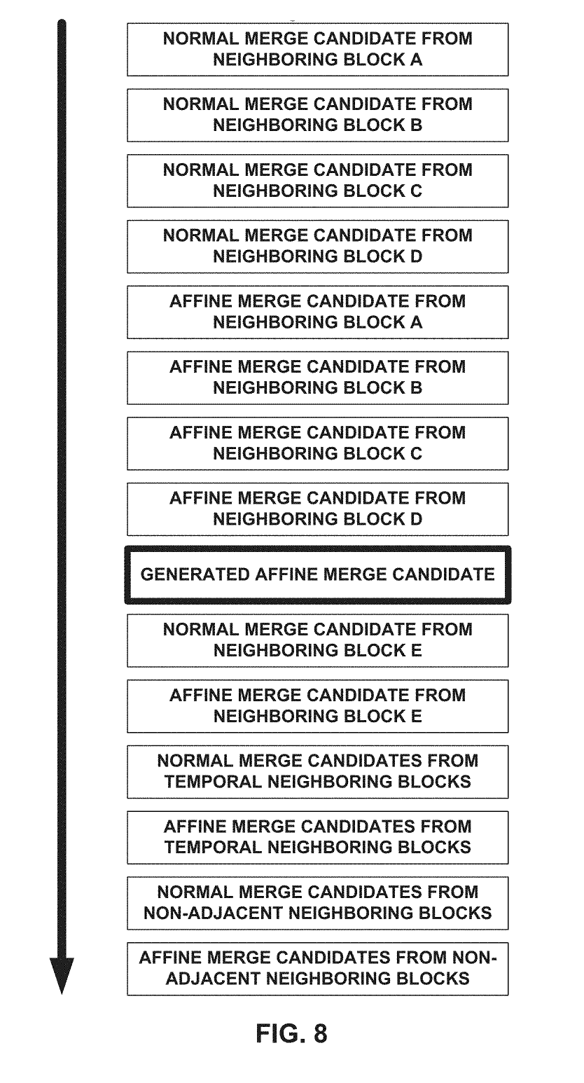

In one example, the generated motion affine motions are treated as one or more affine merge candidates inserted into the unified merge candidate list described in U.S. Application Ser. No. 62/586,117, filed Nov. 14, 2017. As described above, FIG. 5A shows five neighboring blocks used in the merge candidate list construction. FIG. 8 shows an exemplary position where one generated affine merge candidate is put into the merge candidate list, as indicated in bold outline. The generated affine merge candidate may be generated as described above (e.g., by finding motion vectors of neighboring blocks in sets of motion vectors that refer to the same reference picture).

In one example, bit-wise operations such as SHIFT and AND can be used in the searching procedure to find MV_{X}, MV_{Y} and MV_{Z} referring to the same reference picture. An exemplary procedure is revealed as below supposing List X is checked:
1) Variables V0V1V2, V0V1 and V1V2 are initialized to be 0.
2) Variables RefIndexBitSet[3] are initialized to be {0, 0, 0}.
3) For each block M in blocks A, B and C, set RefIndexBitSet[0] =RefIndexBitSet[0] OR (1<<RefIdx[M]), where RefIdx[M] is the reference index used in block M referring to List X, if block M is available, is inter-coded, and has a motion vector referring to List X.
4) For each block M in blocks D and E, set RefIndexBitSet[1] =

RefIndexBitSet[1] OR (1<<RefIdx[M]), where RefIdx[M] is the reference index used in block M referring to List X, if block M is available, is inter-coded, and has a motion vector referring to List X.
5) For each block M in blocks F and G, set RefIndexBitSet[2]=RefIndexBitSet[2] OR (1<<RefIdx[M]), where RefIdx[M] is the reference index used in block M referring to List X, if block M is available, is inter-coded, and has a motion vector referring to List X.
6) Set V0V1V2=RefIndexBitSet[0] AND RefIndexBitSet[1] AND RefIndexBitSet[2].
7) Set V0V1=RefIndexBitSet[0] AND RefIndexBitSet[1].
8) Set V0V2=RefIndexBitSet[0] AND RefIndexBitSet[2].

1 9) If V0V1V2 is equal to 0, there is no MV_{X}, MV_{Y} and MV_{Z} referring to the same reference picture in List X; Otherwise, the smallest R satisfying
V0V1V2 AND (1<<R)==1 is the reference index of the reference picture that MV_{X}, MV_{Y} and MV_{Z} all refer to.
10) If V0V1 is equal to 0, there is no MV_{X}, MV_{Y} referring to the same reference picture in List X; Otherwise, the smallest R satisfying V0V1 AND (1<<R)==1 is the reference index of the reference picture that MV_{X}, MV_{Y} both refer to.
11) If V0V2 is equal to 0, there is no MVₓ, MV_{z} referring to the same reference picture in List X; Otherwise, the smallest R satisfying V0V2 AND (1<<R)==1 is the reference index of the reference picture that MV_{X}, MV_{Z} both refer to.

Affine candidate may be generated from temporal neighboring blocks. For example, the blocks that are used to determine the affine motion vectors may be blocks in a picture other than the picture that includes the block being encoded or decoded.

Accordingly, in one or more examples, video decoder 30 may determine a first set of motion vectors for a first control point (e.g., MVA, MVB, and MVC for the top-left control point as shown in FIG. 7) and determine a second set of motion vectors for a second control point (e.g., MVD and MVE for the top-right control point as shown in FIG. 7). If video decoder 30 receives one or more syntax elements indicating that four-parameter affine is enabled, video decoder 30 may not determine any additional sets of motion vectors. If video decoder 30 receives one or more syntax elements indicate that six-parameter affine is enabled, video decoder 30 may determine a third set of motion vectors for a third control point (e.g., MVF and MVG for the bottom-left control point as shown in FIG. 7).

For four-parameter or six-parameter affine, video decoder 30 may determine that a first motion vector in the first set of motion vectors and a second motion vector in the second set of motion vectors point to a same reference picture. For six-parameter affine, video decoder 30 may also determine a third set of motion vectors. Video decoder 30 may determine that a third motion vector in the third set of motion vectors refers to the same reference picture as the first motion vector and the second motion vector.

For example, video decoder 30 may include memory that stores information indicative of the reference pictures to which previously coded blocks point. Video decoder 30 may determine the reference pictures to which motion vectors in the first set and the second set of motion vectors for four-parameter affine or first, second, and third sets of motion vectors for six-parameter affine point and determine that the first motion vector in the first set of motion vectors and the second motion vector in the second set of motion vectors point to the same reference picture, or the first, second, and third motion vectors from the first, second, and third sets of motion vectors point to the same reference picture. In some examples, video decoder 30 may receive information identifying a particular reference picture, and video decoder 30 may determine that the first motion vector and the second motion vector for four-parameter affine, or the first motion vector, second motion vector, and third motion vector for six-parameter affine, point to the same reference picture if the first motion vector and the second motion vector for four-parameter affine, or the first motion vector, the second motion vector, and the third motion vector for six-parameter affine, point to the identified reference picture.

Video decoder 30 may be configured to determine control point motion vectors for a current block based on the first motion vector and the second motion vector for four-parameter affine or on the first motion vector, the second motion vector, and the third motion vector for six-parameter affine. As one example, video decoder 30 may set the first control point motion vector for a first control point equal to the first motion vector and set a second control point motion vector for a second control point equal to the second motion vector, and further, for six-parameter affine, set a third control point motion vector for a third control point equal to the third motion vector.

As another example, video decoder 30 may add the first motion vector to a first motion vector difference signaled by video encoder 20 to determine the first control point motion vector. Video decoder 30 may add the second motion vector to a second motion vector difference signaled by video encoder 20 to determine the second control point motion vector. For six-parameter affine, video decoder 30 may further add the third motion vector to a third motion vector difference signaled by video encoder 20 to determine the third control point motion vector.

Video decoder 30 may decode the current block based on the determined control point motion vectors. For example, video decoder 30 may determine motion vectors for sub-blocks within the current block based on the control point motion vectors and decode the sub-blocks based on the determined motion vectors for the sub-blocks.

For four-parameter or six-parameter affine, video encoder 20 may be configured to determine that a first motion vector in a first set of motion vectors and a second motion vector in a second set of motion vectors point to a same reference picture. For six-parameter affine, video encoder 20 may be configured to determine that a third motion vector in a third set of motion vectors points to the same reference picture as the first motion vector and the second motion vector.

Video encoder 20 may determine a first control point motion vector and a second control point motion vector. In one example, the first control point motion vector and the second control point motion vector are equal to the first motion vector and the second motion vector, respectively. In one example, the first control point motion vector and the second control point motion vector are equal to the first motion vector plus a first motion vector difference and the second motion vector plus a second motion vector difference, respectively.

For six-parameter affine, video encoder 20 may also determine a third control point motion vector. In one example, the third control point motion vector is equal to the third motion vector. In one example, the third control point motion vector is equal to the third motion vector plus a third motion vector difference.

Video encoder 20 may encode the current block based on the determined first control point motion vector and the second control point motion vector, and further based on the determined third control point motion vector for six-parameter affine. For example, video encoder 20 may determine motion vectors for sub-blocks within the current block based on the control point motion vectors, and encode the sub-blocks based on the determined motion vectors for the sub-blocks.

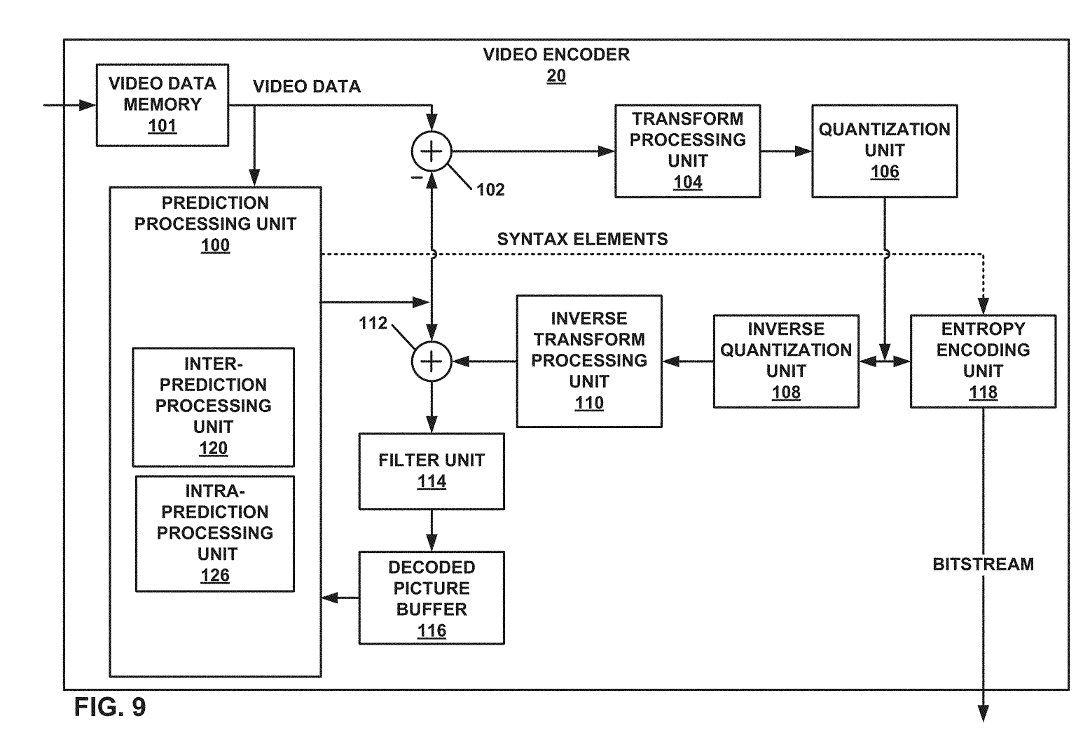

FIG. 9 is a block diagram illustrating an example video encoder 20 that may implement the techniques of this disclosure. FIG. 9 is provided for purposes of explanation and should not be considered limiting of the techniques as broadly exemplified and described in this disclosure. The techniques of this disclosure may be applicable to various coding standards or methods.

In the example of FIG. 9, video encoder 20 includes a prediction processing unit 100, video data memory 101, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 may include a motion estimation unit and a motion compensation unit (not shown).

The various units illustrated in FIG. 9 are examples of fixed-function circuits, programmable circuits, or a combination thereof. For example, the various units illustrated in FIG. 9 may include arithmetic logic units (ALUs), elementary function units (EFUs), logic gates, and other circuitry that can be configured for fixed function operation, configured for programmable operation, or a combination.

Video data memory 101 may be configured to store video data to be encoded by the components of video encoder 20. The video data stored in video data memory 101 may be obtained, for example, from video source 18. Decoded picture buffer 116 may be a reference picture memory that stores reference video data for use in encoding video data by video encoder 20, e.g., in intra- or inter-coding modes. Video data memory 101 and decoded picture buffer 116 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 101 and decoded picture buffer 116 may be provided by the same memory device or separate memory devices. In various examples, video data memory 101 may be on-chip with other components of video encoder 20, or off-chip relative to those components. Video data memory 101 may be in or connected to video encoder 20.

Video encoder 20 receives video data. Video encoder 20 may encode each CTU in a slice of a picture of the video data. Each of the CTUs may be associated with equally-sized luma coding tree blocks (CTBs) and corresponding CTBs of the picture. As part of encoding a CTU, prediction processing unit 100 may perform partitioning to divide the CTBs of the CTU into progressively-smaller blocks. The smaller blocks may be coding blocks of CUs. For example, prediction processing unit 100 may partition a CTB associated with a CTU according to a tree structure.

Video encoder 20 may encode CUs of a CTU to generate encoded representations of the CUs (i.e., coded CUs). As part of encoding a CU, prediction processing unit 100 may partition the coding blocks associated with the CU among one or more PUs of the CU. Thus, each PU may be associated with a luma prediction block and corresponding chroma prediction blocks. Video encoder 20 and video decoder 30 may support PUs having various sizes. As indicated above, the size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or

N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 120 may generate predictive data for a PU. As part of generating the predictive data for a PU, inter-prediction processing unit 120 performs inter prediction on the PU. The predictive data for the PU may include predictive blocks of the PU and motion information for the PU. Inter-prediction processing unit 120 may perform different operations for a PU of a CU depending on whether the PU is in an I slice, a P slice, or a B slice. In an I slice, all PUs are intra predicted. Hence, if the PU is in an I slice, inter-prediction processing unit 120 does not perform inter prediction on the PU. Thus, for blocks encoded in I-mode, the predicted block is formed using spatial prediction from previously-encoded neighboring blocks within the same frame. If a PU is in a P slice, inter-prediction processing unit 120 may use uni-directional inter prediction to generate a predictive block of the PU. If a PU is in a B slice, inter-prediction processing unit 120 may use uni-directional or bi-directional inter prediction to generate a predictive block of the PU.

Inter-prediction processing unit 120 may apply the techniques for affine motion vectors (e.g., control point motion vectors) as described elsewhere in this disclosure. For example, inter-prediction processing unit 120 may perform the example operations described above for the motion vector generation such as based on sets of motion vectors having motion vectors that refer to the same reference picture, but, in some examples, are not equal to each other. Although inter-prediction processing unit 120 is described as performing the example operations, in some examples, one or more other units in addition to or instead of inter-prediction processing unit 120 may perform the example methods, and the techniques are not limited to inter-prediction processing unit 120 performing the example operations.

Intra-prediction processing unit 126 may generate predictive data for a PU by performing intra prediction on the PU. The predictive data for the PU may include predictive blocks of the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. Intra-prediction processing unit 126 may use samples from sample blocks of neighboring PUs to generate a predictive block for a PU. The neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes, e.g., 33 directional intra prediction modes. In some examples, the number of intra prediction modes may depend on the size of the region associated with the PU.

Prediction processing unit 100 may select the predictive data for PUs of a CU from among the predictive data generated by inter-prediction processing unit 120 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive blocks of the selected predictive data may be referred to herein as the selected predictive blocks.

Residual generation unit 102 may generate, based on the coding blocks (e.g., luma, Cb and Cr coding blocks) for a CU and the selected predictive blocks (e.g., predictive luma, Cb and Cr blocks) for the PUs of the CU, residual blocks (e.g., luma, Cb and Cr residual blocks) for the CU. For instance, residual generation unit 102 may generate the residual blocks of the CU such that each sample in the residual blocks has a value equal to a difference between a sample in a coding block of the CU and a corresponding sample in a corresponding selected predictive block of a PU of the CU.

Transform processing unit 104 may partition the residual blocks of a CU into transform blocks of TUs of the CU. For instance, transform processing unit 104 may perform quad-tree partitioning to partition the residual blocks of the CU into transform blocks of TUs of the CU. Thus, a TU may be associated with a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT.

Transform processing unit 104 may generate transform coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually similar transform to a transform block. In some examples, transform processing unit 104 does not apply transforms to a transform block. In such examples, the transform block may be treated as a transform coefficient block.

Quantization unit 106 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU. Quantization may introduce loss of information. Thus, quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive blocks generated by prediction processing unit 100 to produce a reconstructed transform block associated with a TU. By reconstructing transform blocks for each TU of a CU in this way, video encoder 20 may reconstruct the coding blocks of the CU.

Filter unit 114 may perform one or more deblocking operations to reduce blocking artifacts in the coding blocks associated with a CU. Decoded picture buffer 116 may store the reconstructed coding blocks after filter unit 114 performs the one or more deblocking operations on the reconstructed coding blocks. Inter-prediction processing unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a CABAC operation, a context-adaptive variable length coding (CAVLC) operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. For instance, the bitstream may include data that represents values of transform coefficients for a CU.

Video encoder 20 may be configured to perform the example affine motion prediction techniques described in this disclosure. As one example, and as described above, inter-prediction processing unit 120 may be configured to perform the example techniques. For instance, video data memory 101 may store information indicative of the reference pictures to which motion vectors of previously encoded blocks point. As one example, referring to FIG. 7, the blocks A, B, C, D, E, F, and G may be blocks the video encoder 20 previously encoded, and video data memory 101 or DPB 116 may store information of the motion vectors for blocks A-F and the reference pictures to which the motion vectors for blocks A-F point.

Inter-prediction processing unit 120 may determine a first set of motion vectors for a first control point, a second set of motion vectors for a second control point, and, if six-parameter affine is enabled, a third set of motion vectors for a third control point. The first set of motion vectors may be motion vectors for first, second, and third blocks (e.g., MVA, MVB, and MVC for blocks A, B, and C, respectively). The second set of motion vectors may be motion vectors for fourth and fifth blocks (e.g., MVD and MVE for blocks D and E, respectively). The third set of motion vectors may be motion vectors for sixth and seventh blocks (e.g., MVF and MVG for blocks F and G, respectively).

Inter-prediction processing unit 120 may determine a first control point motion vector and a second control point motion vector for a current block. For instance, inter-prediction processing unit 120 may test different control point motion vectors until inter-prediction processing unit 120 identifies control point motion vectors that provide the right balance of coding gains and signaling efficiency. For instance, in one example, inter-prediction processing unit 120 may determine that a first motion vector in the first set of motion vectors and a second motion vector in the second set of motion vectors point to the same reference picture. For six-parameter affine, inter-prediction processing unit 120 may also determine that a third motion vector in the third set of motion vectors points to the same reference picture as the first and second motion vectors.

In one example, inter-prediction processing unit 120 may set the first control point motion vector and the second control point motion vector equal to the first motion vector and the second motion vector, respectively. In one example, inter-prediction processing unit 120 may determine that the first motion vector and the second motion vector should be predictors for the first control point motion vector and the second control point motion vector. In such an example, inter-prediction processing unit 120 may determine that the first control motion vector and the second control motion vector are equal to the first motion vector plus a first motion vector difference and the second motion vector plus a second motion vector difference, respectively.

For six-parameter affine, inter-prediction processing unit 120 may, as one example, set the third control point motion vector equal to the third motion vector. In another example, inter-prediction processing unit 120 may determine that the third motion vector should be a predictor for the third control point motion vector. In such an example, inter-prediction processing unit 120 may determine that the third control point motion vector is equal to the third motion vector plus a third motion vector difference.

Inter-prediction processing unit 120 may be further configured to encode the current block based on the determined first control point motion vector and the second control point motion vector. For six-parameter affine, inter-prediction processing unit 120 may also encode the current block based on the determine third control point motion vector. As one example, inter-prediction processing unit 120 may determine motion vectors for sub-blocks of the current block based on the first and second control point motion vectors, and for six-parameter affine, also based on the third control point motion vector. Inter-prediction processing unit 120 may encode the sub-blocks based on the determined motion vectors for the sub-blocks.

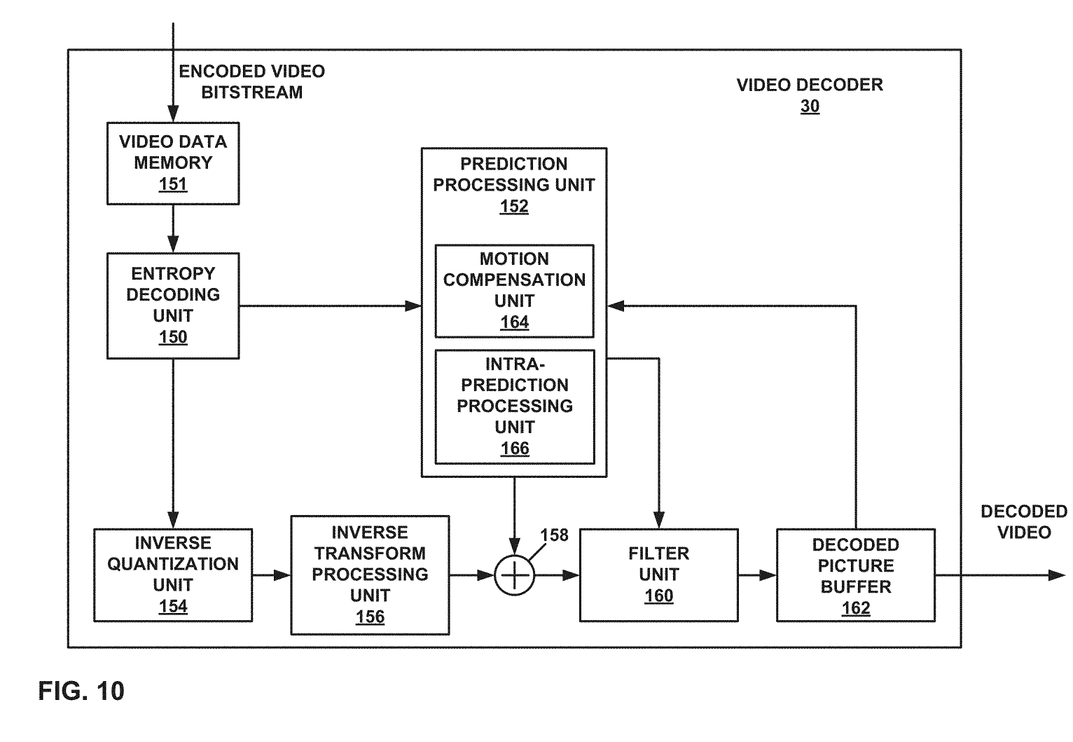

FIG. 10 is a block diagram illustrating an example video decoder 30 that is configured to implement the techniques of this disclosure. FIG. 10 is provided for purposes of explanation and is not limiting on the techniques as broadly exemplified and described in this disclosure. For purposes of explanation, this disclosure describes video decoder 30 in the context of HEVC coding as an example. However, the techniques of this disclosure may be applicable to other coding standards or methods.

In the example of FIG. 10, video decoder 30 includes an entropy decoding unit 150, video data memory 151, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. In other examples, video decoder 30 may include more, fewer, or different functional components.

The various units illustrated in FIG. 10 are examples of fixed-function circuits, programmable circuits, or a combination. For example, the various units illustrated in FIG. 10 may include arithmetic logic units (ALUs), elementary function units (EFUs), logic gates, and other circuitry that can be configured for fixed function operation, configured for programmable operation, or a combination.

Video data memory 151 may store encoded video data, such as an encoded video bitstream, to be decoded by the components of video decoder 30. The video data stored in video data memory 151 may be obtained, for example, from computer-readable medium 16, e.g., from a local video source, such as a camera, via wired or wireless network communication of video data, or by accessing physical data storage media. The video data may be encoded video data such as that encoded by video encoder 20. Video data memory 151 may form a coded picture buffer (CPB) that stores encoded video data from an encoded video bitstream. Decoded picture buffer 162 may be a reference picture memory that stores reference video data for use in decoding video data by video decoder 30, e.g., in intra- or inter-coding modes, or for output. Video data memory 151 and decoded picture buffer 162 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 151 and decoded picture buffer 162 may be provided by the same memory device or separate memory devices. In various examples, video data memory 151 may be on-chip with other components of video decoder 30, or off-chip relative to those components. Video data memory 151 may be the same as or part of storage media 28 of FIG. 1.

Video data memory 151 receives and stores encoded video data (e.g., NAL units) of a bitstream. Entropy decoding unit 150 may receive encoded video data (e.g., NAL units) from video data memory 151 and may parse the NAL units to obtain syntax elements. Entropy decoding unit 150 may entropy decode (e.g., using CABAC) entropy-encoded syntax elements in the NAL units. Prediction processing unit 152, inverse quantization unit 154, inverse transform processing unit 156, reconstruction unit 158, and filter unit 160 may generate decoded video data based on the syntax elements extracted from the bitstream. Entropy decoding unit 150 may perform a process generally reciprocal to that of entropy encoding unit 118.

In addition to obtaining syntax elements from the bitstream, video decoder 30 may perform a reconstruction operation on a non-partitioned CU. To perform the reconstruction operation on a CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, inverse quantization unit 154 may inverse quantize, i.e., de-quantize, coefficient blocks associated with the TU. After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

Inverse quantization unit 154 may perform particular techniques of this disclosure. For example, for at least one respective quantization group of a plurality of quantization groups within a CTB of a CTU of a picture of the video data, inverse quantization unit 154 may derive, based at least in part on local quantization information signaled in the bitstream, a respective quantization parameter for the respective quantization group. Additionally, in this example, inverse quantization unit 154 may inverse quantize, based on the respective quantization parameter for the respective quantization group, at least one transform coefficient of a transform block of a TU of a CU of the CTU. In this example, the respective quantization group is defined as a group of successive, in coding order, CUs or coding blocks so that boundaries of the respective quantization group must be boundaries of the CUs or coding blocks and a size of the respective quantization group is greater than or equal to a threshold. Video decoder 30 (e.g., inverse transform processing unit 156, reconstruction unit 158, and filter unit 160) may reconstruct, based on inverse quantized transform coefficients of the transform block, a coding block of the CU.

If a PU is encoded using intra prediction, intra-prediction processing unit 166 may perform intra prediction to generate predictive blocks of the PU. Intra-prediction processing unit 166 may use an intra prediction mode to generate the predictive blocks of the PU based on samples spatially-neighboring blocks. Intra-prediction processing unit 166 may determine the intra prediction mode for the PU based on one or more syntax elements obtained from the bitstream.

If a PU is encoded using inter prediction, entropy decoding unit 150 may determine motion information for the PU. Motion compensation unit 164 (also called inter-prediction processing unit 164) may determine, based on the motion information of the PU, one or more reference blocks. Motion compensation unit 164 may generate, based on the one or more reference blocks, predictive blocks (e.g., predictive luma, Cb and Cr blocks) for the PU.

Motion compensation unit 164 may apply the techniques for affine motion models as described elsewhere in this disclosure. For example, motion compensation unit 164 may perform the example operations described above for the motion vector generation such as based on sets of motion vectors having motion vectors that refer to the same reference picture, but, in some examples, are not equal to each other. Although motion compensation unit 164 is described as performing the example operations, in some examples, one or more other units in addition to or instead of motion compensation unit 164 may perform the example methods, and the techniques are not limited to motion compensation unit 164 performing the example operations.

Reconstruction unit 158 may use transform blocks (e.g., luma, Cb and Cr transform blocks) for TUs of a CU and the predictive blocks (e.g., luma, Cb and Cr blocks) of the PUs of the CU, i.e., either intra-prediction data or inter-prediction data, as applicable, to reconstruct the coding blocks (e.g., luma, Cb and Cr coding blocks) for the CU. For example, reconstruction unit 158 may add samples of the transform blocks (e.g., luma, Cb and Cr transform blocks) to corresponding samples of the predictive blocks (e.g., luma, Cb and Cr predictive blocks) to reconstruct the coding blocks (e.g., luma, Cb and Cr coding blocks) of the CU.

Filter unit 160 may perform a deblocking operation to reduce blocking artifacts associated with the coding blocks of the CU. Video decoder 30 may store the coding blocks of the CU in decoded picture buffer 162. Decoded picture buffer 162 may provide reference pictures for subsequent motion compensation, intra prediction, and presentation on a display device, such as display device 32 of FIG. 1. For instance, video decoder 30 may perform, based on the blocks in decoded picture buffer 162, intra prediction or inter prediction operations for PUs of other CUs.

Certain aspects of this disclosure have been described with respect to HEVC or extensions of the HEVC standard for purposes of illustration. However, the techniques described in this disclosure may be useful for other video coding processes, including other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding, as applicable. In this disclosure, the phrase “based on” may indicate based only on, based at least in part on, or based in some way on. This disclosure may use the term “video unit” or “video block” or “block” to refer to one or more sample blocks and syntax structures used to code samples of the one or more blocks of samples. Example types of video units may include CTUs, CUs, PUs, transform units (TUs), macroblocks, macroblock partitions, and so on. In some contexts, discussion of PUs may be interchanged with discussion of macroblocks or macroblock partitions. Example types of video blocks may include coding tree blocks, coding blocks, and other types of blocks of video data.

Video decoder 30 is an example of at least one of fixed-function or programmable circuitry (e.g., fixed-function and/or programmable circuitry) that is configured to perform example techniques described in this disclosure. For instance, as described above, motion compensation unit 164 may be configured to perform the example techniques.

As one example, video data memory 151 may store information indicative of reference pictures to which motion vectors point (e.g., motion vectors of previously decoded blocks stored in decoded picture buffer 162). In some examples, decoded picture buffer 162 may store information indicative of reference pictures to which motion vectors point.

Motion compensation unit 164 may determine a first set of motion vectors for a first control point and a second set of motion vectors for a second control point. For six-parameter affine, motion compensation unit 164 may determine a third set of motion vectors for a third control point. As one example, as illustrated in FIG. 7, the first set of motion vectors may be motion vectors for a first, second, and third block (e.g., MVA of block A, MVB of block B, and MVC of block C). The second set of motion vectors may be motion vectors for a fourth and fifth block (e.g., MVD of block D and MVE of block E). For six-parameter affine, the third set of motion vectors may be motion vectors for a sixth and seventh block (e.g., MVF of block F and MVG of block G).

Motion compensation unit 164 may determine that a first motion vector in the first set of motion vectors and a second motion vector in the second set of motion vectors point to the same reference picture based on the stored information. For six-parameter affine, motion compensation unit 164 may determine that a third motion vector in the third set of motion vectors points to the same reference picture as the first and second motion vectors based on the stored information.

For example, motion compensation unit 164 may compare the reference pictures to which the motion vectors in the first, second, and third sets of motion vectors point and determine that there is a first and a second motion vector that point to the same reference picture for four-parameter affine or there is a first, second, and third motion vector that point to the same reference picture for six-parameter affine. As another example, motion compensation unit 164 may receive information identifying a particular reference picture. Motion compensation unit 164 may determine whether a motion vector in the each of the first and second, for four-parameter affine, or first, second, and third, for six-parameter affine, sets of motion vectors point to the identified reference picture. This is another example way in which motion compensation unit 164 may determine that a first motion vector in the first set of motion vectors, that a second motion vector in the second set of motion vectors, and for six-parameter affine, that a third motion vector in the third set of motion vectors point to the same reference picture.

Motion compensation unit 164 may determine control point motion vectors for a current block based on the first motion vector and the second motion vector for four-parameter affine or based on the first motion vector, the second motion vector, and the third motion vector for six-parameter affine. As one example, motion compensation unit 164 may determine a first control point motion vector based on the first motion vector, a second control point motion vector based on the second motion vector, and for six-parameter affine, a third control point motion vector based on the third motion vector.

For example, video decoder 30 may receive one or more syntax elements that indicate whether four-parameter affine is enabled for the current block or whether six-parameter affine is enabled for the current block. In one example, video decoder 30 may determine, based on the received one or more syntax elements, that four-parameter affine is enabled for the current block. In this example, responsive to the determination that four-parameter affine is enabled, motion compensation unit 164 may determine the control point motion vectors for the current block based on the first motion vector and the second motion vector. In one example, video decoder 30 may determine, based on the received one or more syntax elements, that six-parameter affine is enabled for the current block. In this example, responsive to the determination that six-parameter affine is enabled, motion compensation unit 164 may determine the control point motion vectors for the current block based on the first motion vector, the second motion vector, and the third motion vector.

In some examples, motion compensation unit 164 may set the first control point motion vector equal to the first motion vector, set the second control point motion vector equal to the second motion vector, and for six-parameter affine, set the third control point motion vector equal to the third motion vector. In some examples, motion compensation unit 164 may receive a first motion vector difference which is a difference signaled by video encoder 20 of the difference between the first control point motion vector and the first motion vector. Similarly, motion compensation unit 164 may receive a second motion vector difference which is a difference signaled by video encoder 20 of the difference between the second control point motion vector and the second motion vector. For six-parameter affine, motion compensation unit 164 may additionally receive a third motion vector difference which is a difference signaled by video encoder 20 of the difference between the third control point motion vector and the third motion vector. In such examples, motion compensation unit 164 may add the first motion vector to the first motion vector difference to determine the first control point motion vector, add the second motion vector to the second motion vector difference to determine the second control point motion vector, and for six-parameter affine, add the third motion vector to the third motion vector difference to determine the third control point motion vector.

Motion compensation unit 164 in combination with reconstruction unit 158 may be configured to decode the current block based on the determined control point motion vectors. For example, motion compensation unit 164 may determine motion vectors for sub-blocks of the current block based on the control point motion vectors, and decode the sub-blocks based on the determined motion vector. Motion compensation unit 164 may determine reference sub-blocks for each of the sub-blocks based on the determined motion vector, and reconstruction unit 158 may sum the reference sub-blocks with residual data for the sub-blocks, signaled by video encoder 20, to reconstruct the sub-blocks (e.g., decode the sub-blocks).

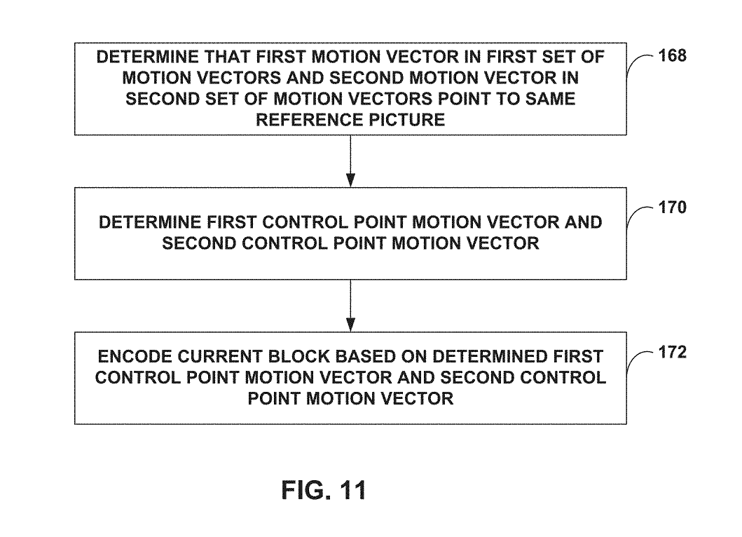

FIG. 11 is a flowchart illustrating an example method of operation in accordance with one or more example techniques described in this disclosure. FIG. 11 illustrates example operations by video encoder 20. Video encoder 20 (e.g., via inter-prediction processing unit 120) may determine that a first motion vector in a first set of motion vectors and a second motion vector in a second set of motion vectors point to the same reference picture (168). For six-parameter affine, video encoder 20 may determine that a third motion vector in a third set of motion vectors points to the same reference picture as the first and second motion vectors. In some examples, video encoder 20 may determine the first set of motion vectors based on motion vectors for first, second, and third blocks, respectively, (e.g., MVA, MVB, and MVC), determine the second set of motion vectors based on motion vectors for fourth and fifth blocks, respectively, (e.g., MVD and MVE), and for six-parameter affine determine the third set of motion vectors for sixth and seventh blocks, respectively (e.g., MVG and MVF).

Video encoder 20 may be configured to determine a first control point motion vector for a first control point and a second control point motion vector for a second control point (170). For six-parameter affine, video encoder 20 may be configured to also determine a third control point motion vector for a third control point. In one example, the first control point motion vector is equal to the first motion vector, the second control point motion vector is equal to the second motion vector, and for six-parameter affine, the third control point motion vector is equal to the third motion vector. In one example, the first control point motion vector is equal to the first motion vector plus a first motion vector difference, where the first motion vector difference is the difference between the first control point motion vector determined by video encoder 20 and the first motion vector. Also, the second control point motion vector is equal to the second motion vector plus a second motion vector difference, where the second motion vector difference is the difference between the second control point motion vector determined by video encoder 20 and the second motion vector. For six-parameter affine, the third control point motion vector is equal to the third motion vector plus a third motion vector difference, where the third motion vector difference is the difference between the third control point motion vector determined by video encoder 20 and the third motion vector.

Video encoder 20 may encode the current block based on the determined first control point motion vector and the second control point motion vector (172). For six-parameter affine, video encoder 20 may encode the current block also based on the determined third control point motion vector. As one example, video encoder 20 may determine motion vectors for sub-blocks within the current block based on the control point motion vectors, and encode the sub-blocks based on the determined motion vectors for the sub-blocks. For example, video encoder 20 may determine a residual between reference sub-blocks pointed to by the motion vectors of the sub-blocks and the sub-blocks and signal information indicative of the residual as a way to encode the sub-blocks of the current block.

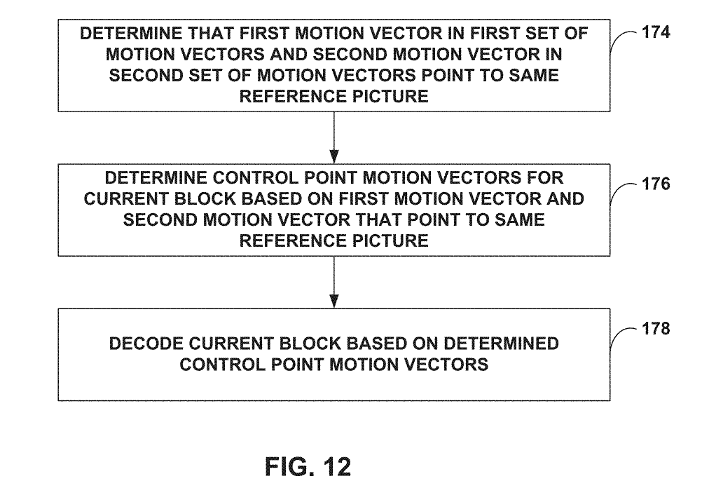

FIG. 12 is a flowchart illustrating an example method of operation in accordance with one or more example techniques described in this disclosure. FIG. 12 illustrates example operations by video decoder 30. Video decoder 30 (e.g., via motion compensation unit 164) may determine that a first motion vector in a first set of motion vectors and a second motion vector in a second set of motion vectors point to the same reference picture based on information stored in memory (e.g., video data memory 151 or decoded picture buffer 162 indicative of reference pictures to which motion vectors point) (174). For six-parameter affine, video decoder 30 may determine that a third motion vector in a third set of motion vectors points to the same reference picture as the first and second motion vectors.

Video decoder 30 may be configured to determine whether four-parameter or six-parameter affine is enabled based on signaled information. For example, video decoder 30 may receive one or more syntax elements that indicate whether four-parameter or six-parameter affine is enabled. Video decoder 30 may determine the first and second sets of motion vectors for both the four-parameter and six-parameter affine. If six-parameter affine is enabled, video decoder 30 may further determine the third set of motion vectors.

As one example, video decoder 30 may determine the first set of motion vectors based on motion vectors of a first, second, and third block (e.g., blocks A, B, and C having motion vectors MVA, MVB, and MVC as illustrated in FIG. 7). Video decoder 30 may determine the second set of motion vectors based on motion vectors of a fourth and fifth block (e.g., blocks D and E having motion vectors MVD and MVE as illustrated in FIG. 7). For six-parameter affine, video decoder 30 may determine the third set of motion vectors based on motion vectors of a sixth and seventh block (e.g., blocks F and G having motion vectors MVF and MVG).

There may be various ways in which video decoder 30 may determine that a first motion vector in the first set of motion vectors, a second motion vector in the second set of motion vectors, and for six-parameter affine, a third motion vector in the third set of motion vectors point to the same reference picture. As one example, video decoder 30 may compare the reference pictures to which the motion vectors in the sets of motion vectors point to determine motion vectors in each set of motion vectors that point to the same reference picture. As another example, video decoder 30 may receive information identifying a particular reference picture. Video decoder 30 may determine whether each set of motion vectors includes a motion vector that points to the identified reference picture. This is another way in which video decoder 30 may determine that there is a first motion vector in the first set motion vectors, a second motion vector in the second set of motion vectors, and for six-parameter affine, a third motion vector in the third set of motion vectors that point to the same reference picture.

Video decoder 30 may determine control point motion vectors for the current block based on the first motion vector and the second motion vector that point to the same reference picture (176). Responsive to the one or more syntax elements indicating that four-parameter affine is enabled, video decoder 30 may determine a first control point motion vector for a first control point and determine a second control point motion vector for a second control point. Responsive to the one or more syntax elements indicating that six-parameter affine is enabled, video decoder 30 may determine a first control point motion vector for a first control point, determine a second control point motion vector for a second control point, and determine a third control point motion vector for a third control point.

As one example, video decoder 30 may set the first control point motion vector equal to the first motion vector and set the second control point motion vector equal to the second motion vector. For six-parameter affine, video decoder 30 may further set the third control point motion vector equal to the third motion vector.

As another example, video decoder 30 may receive a first motion vector difference from video encoder 20. The first motion vector difference is the difference between the first control point motion vector and the first motion vector. In this example, video decoder 30 may add the first motion vector to the first motion vector difference to determine the first control point motion vector. Also, video decoder 30 may receive a second motion vector difference and for six-parameter affine a third motion vector difference from video encoder 20. The second motion vector difference is the difference between the second control point motion vector and the second motion vector, and the third motion vector difference is the difference between the third control point motion vector and the third motion vector. In this example, video decoder 30 may add the second motion vector to the second motion vector difference to determine the second control point motion vector, and for six-parameter affine, add the third motion vector to the third motion vector difference to determine the third control point motion vector.

Video decoder 30 may decode the current block based on the determined control point motion vectors (178). For example, video decoder 30 may determine motion vectors for sub-blocks within the current block based on the determined control point motion vectors and may decode the sub-blocks based on the determined motion vectors. For instance, video decoder 30 may determine reference sub-blocks based on the determined motion vectors and may receive residual information indicating the difference between the reference sub-blocks and the sub-blocks of the current block. Video decoder 30 may add the residual information to the reference sub-blocks to reconstruct the sub-blocks of the current block (e.g., to decode the sub-blocks of the current block).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining that a first motion vector in a first set of motion vectors and a second motion vector in a second set of motion vectors point to a same reference picture;
determining control point motion vectors for a current block based on the first motion vector and the second motion vector that point to the same reference picture; and
decoding the current block based on the determined control point motion vectors.

2. The method of claim 1, wherein determining control point motion vectors comprises:
determining a first control point motion vector for a first control point based on the first motion vector; and
determining a second control point motion vector for a second control point based on the second motion vector.

3. The method of claim 2, wherein determining the first control point motion vector for the first control point based on the first motion vector comprises setting the first control point motion vector equal to the first motion vector, and wherein determining the second control point motion vector for the second control point based on the second motion vector comprises setting the second control point motion vector equal to the second motion vector.

4. The method of claim 2, wherein determining the first control point motion vector for the first control point based on the first motion vector comprises adding the first motion vector to a first motion vector difference to determine the first control point motion vector, and wherein determining the second control point motion vector for the second control point based on the second motion vector comprises adding the second motion vector to a second motion vector difference to determine the second control point motion vector.

5. The method of claim 1, further comprising:
determining a third set of motion vectors;
determining that a third motion vector in the third set of motion vectors refers to the same reference picture as the first motion vector and the second motion vector; and
determining a third control point motion vector for the current block based on the third motion vector,
wherein decoding the current block comprises decoding the current block based on the first control point motion vector, the second control point motion vector, and the third control point motion vector.

6. The method of claim 5, wherein the first set of motion vectors comprises one or more of a motion vector for a first block, a motion vector for a second block, and a motion vector for a third block, wherein the second set of motion vectors comprises one or more of a motion vector for a fourth block and a motion vector for a fifth block, and wherein the third set of motion vectors comprises one or more of a motion vector for a sixth block and a motion vector for a seventh block.

7. The method of claim 1, wherein the first set of motion vectors comprises one or more of a motion vector for a first block, a motion vector for a second block, and a motion vector for a third block, and wherein the second set of motion vectors comprises one or more of a motion vector for a fourth block and a motion vector for a fifth block.

8. The method of claim 1, further comprising:
determining, based on received one or more syntax elements, that four-parameter affine is enabled for the current block,
wherein determining control point motion vectors comprises, responsive to the determination that four-parameter affine is enabled, determining the control point motion vectors for the current block based on the first motion vector and the second motion vector.

9. The method of claim 1, further comprising:
determining, based on received one or more syntax elements, that six-parameter affine is enabled for the current block;
responsive to the determination that the six-parameter affine is enabled:
determining a third set of motion vectors; and
determining that a third motion vector from the third set of motion vectors refers to the same reference picture as the first motion vector and the second motion vector,
wherein determining control point motion vectors comprises, responsive to the determination that six-parameter affine is enabled, determining the control point motion vectors for the current block based on the first motion vector, the second motion vector, and the third motion vector.

10. The method of claim 1, wherein decoding the current block based on the determined control point motion vectors comprises:
determining motion vectors for sub-blocks within the current block based on the control point motion vectors; and
decoding the sub-blocks based on the determined motion vectors for the sub-blocks.

11. A method of encoding video data, the method comprising:
determining that a first motion vector in a first set of motion vectors and a second motion vector in a second set of motion vectors point to a same reference picture;
determining a first control point motion vector and a second control point motion vector for a current block, wherein the first control point motion vector and the second control point motion vector are one of:
equal to the first motion vector and the second motion vector, respectively; or
equal to the first motion vector plus a first motion vector difference and the second motion vector plus a second motion vector difference, respectively;
encoding the current block based on the determined first control point motion vector and the second control point motion vector.

12. The method of claim 11, further comprising:
determining a third set of motion vectors;
determining that a third motion vector in the third set of motion vectors refers to the same reference picture as the first motion vector and the second motion vector; and
determining a third control point motion vector for the current block, wherein the third control point motion vector is one of:
equal to the third motion vector; or
equal to the third motion vector plus a third motion vector difference;
wherein encoding the current block comprises encoding the current block based on the first control point motion vector, the second control point motion vector, and the third control point motion vector.

13. The method of claim 12, wherein the first set of motion vectors comprises one or more of a motion vector for a first block, a motion vector for a second block, and a motion vector for a third block, wherein the second set of motion vectors comprises one or more of a motion vector for a fourth block and a motion vector for a fifth block, and wherein the third set of motion vectors comprises one or more of a motion vector for a sixth block and a motion vector for a seventh block.

14. The method of claim 11, wherein the first set of motion vectors comprises one or more of a motion vector for a first block, a motion vector for a second block, and a motion vector for a third block, and wherein the second set of motion vectors comprises one or more of a motion vector for a fourth block and a motion vector for a fifth block.

15. The method of claim 11, wherein encoding the current block based on the determined first control point motion vector and the second control point motion vector comprises:
determining motion vectors for sub-blocks within the current block based on the first and second control point motion vectors; and
encoding the sub-blocks based on the determined motion vectors for the sub-blocks.

16. A device for decoding video data, the device comprising:
a memory configured to store information indicative of reference pictures to which motion vectors point; and
a video decoder comprising at least one of fixed-function or programmable circuitry, wherein the video decoder is configured to:
determine that a first motion vector in a first set of motion vectors and a second motion vector in a second set of motion vectors point to a same reference picture based on the stored information;
determine control point motion vectors for a current block based on the first motion vector and the second motion vector that point to the same reference picture; and
decode the current block based on the determined control point motion vectors.

17. The device of claim 16, wherein to determine control point motion vectors, the video decoder is configured to:
determine a first control point motion vector for a first control point based on the first motion vector; and
determine a second control point motion vector for a second control point based on the second motion vector.

18. The device of claim 17, wherein to determine the first control point motion vector for the first control point based on the first motion vector, the video decoder is configured to set the first control point motion vector equal to the first motion vector, and wherein to determine the second control point motion vector for the second control point based on the second motion vector, the video decoder is configured to set the second control point motion vector equal to the second motion vector.

19. The device of claim 17, wherein to determine the first control point motion vector for the first control point based on the first motion vector, the video decoder is configured to add the first motion vector to a first motion vector difference to determine the first control point motion vector, and wherein to determine the second control point motion vector for the second control point based on the second motion vector, the video decoder is configured to add the second motion vector to a second motion vector difference to determine the second control point motion vector.

20. The device of claim 16, wherein the video decoder is configured to:
determine a third set of motion vectors;
determine that a third motion vector in the third set of motion vectors refers to the same reference picture as the first motion vector and the second motion vector; and
determine a third control point motion vector for the current block based on the third motion vector,
wherein to decode the current block, the video decoder is configured to decode the current block based on the first control point motion vector, the second control point motion vector, and the third control point motion vector.

21. The device of claim 20, wherein the first set of motion vectors comprises one or more of a motion vector for a first block, a motion vector for a second block, and a motion vector for a third block, wherein the second set of motion vectors comprises one or more of a motion vector for a fourth block and a motion vector for a fifth block, and wherein the third set of motion vectors comprises one or more of a motion vector for a sixth block and a motion vector for a seventh block.

22. The device of claim 16, wherein the first set of motion vectors comprises one or more of a motion vector for a first block, a motion vector for a second block, and a motion vector for a third block, and wherein the second set of motion vectors comprises one or more of a motion vector for a fourth block and a motion vector for a fifth block.

23. The device of claim 16, wherein the video decoder is configured to:
determine, based on received one or more syntax elements, that four-parameter affine is enabled for the current block,
wherein to determine control point motion vectors, the video decoder is configured to, responsive to the determination that four-parameter affine is enabled, determine the control point motion vectors for the current block based on the first motion vector and the second motion vector.

24. The device of claim 16, wherein the video decoder is configured to:
determine, based on received one or more syntax elements, that six-parameter affine is enabled for the current block; and
responsive to the determination that the six-parameter affine is enabled:
determine a third set of motion vectors; and
determine that a third motion vector from the third set of motion vectors refers to the same reference picture as the first motion vector and the second motion vector,
wherein to determine control point motion vectors, the video decoder is configured to, responsive to the determination that six-parameter affine is enabled, determine the control point motion vectors for the current block based on the first motion vector, the second motion vector, and the third motion vector.

25. The device of claim 16, wherein to decode the current block based on the determined control point motion vectors, the video decoder is configured to:
determine motion vectors for sub-blocks within the current block based on the control point motion vectors; and
decode the sub-blocks based on the determined motion vectors for the sub-blocks.

26. A computer-readable storage medium storing instructions thereon that when executed cause one or more processors for a device for encoding video data to:
determine that a first motion vector in a first set of motion vectors and a second motion vector in a second set of motion vectors point to a same reference picture;
determine a first control point motion vector and a second control point motion vector for a current block, wherein the first control point motion vector and the second control point motion vector are one of:
equal to the first motion vector and the second motion vector, respectively; or
equal to the first motion vector plus a first motion vector difference and the second motion vector plus a second motion vector difference, respectively;
encode the current block based on the determined first control point motion vector and the second control point motion vector.

27. The computer-readable storage medium of claim 26, further comprising instructions that cause the one or more processors to:
determine a third set of motion vectors;
determine that a third motion vector in the third set of motion vectors refers to the same reference picture as the first motion vector and the second motion vector; and
determine a third control point motion vector for the current block, wherein the third control point motion vector is one of:
equal to the third motion vector; or equal to the third motion vector plus a third motion vector difference;
wherein the instructions that cause the one or more processors to encode the current block comprise instructions that cause the one or more processors to encode the current block based on the first control point motion vector, the second control point motion vector, and the third control point motion vector.

28. The computer-readable storage medium of claim 27, wherein the first set of motion vectors comprises one or more of a motion vector for a first block, a motion vector for a second block, and a motion vector for a third block, wherein the second set of motion vectors comprises one or more of a motion vector for a fourth block and a motion vector for a fifth block, and wherein the third set of motion vectors comprises one or more of a motion vector for a sixth block and a motion vector for a seventh block.

29. The computer-readable storage medium of claim 26, wherein the first set of motion vectors comprises one or more of a motion vector for a first block, a motion vector for a second block, and a motion vector for a third block, and wherein the second set of motion vectors comprises one or more of a motion vector for a fourth block and a motion vector for a fifth block.

30. The computer-readable storage medium of claim 26, wherein the instructions that cause the one or more processors to encode the current block based on the determined first control point motion vector and the second control point motion vector comprise instructions that cause the one or more processors to:
determine motion vectors for sub-blocks within the current block based on the first and second control point motion vectors; and
encode the sub-blocks based on the determined motion vectors for the sub-blocks.
